(19) United States
(12) Patent Application Publication
(10) Pub. No.: US 2025/0059944 A1
(43) Pub. Date: Feb. 20, 2025

(54) FAMILY OF AIRFOILS FOR FLUID TURBINE WITH PASSIVE-PITCHING ROTOR BLADES

(71) Applicant: Vincent Loccisano, Wellesley, MA (US)

(72) Inventor: Vincent Loccisano, Wellesley, MA (US)

(21) Appl. No.: 18/628,944

(22) Filed: Apr. 8, 2024

Related U.S. Application Data
(60) Provisional application No. 63/494,937, filed on Apr. 7, 2023.

(51) Int. Cl. F03D 1/06

(52) U.S. Cl. CPC F03D 1/0675; F05B 2240/301

(57) ABSTRACT

A fluid turbine has a rotor-blade design with aerodynamic pitch control. A high-operating lift coefficient, combined with high-operating efficiency as a ratio of lift over drag, provides sufficient pitching moment to pitch the rotor blade in excessive winds. The aerodynamic properties of the airfoil design comprise laminar and turbulent flow effects that provide roughness insensitivity. Some embodiments comprise hybrid actuated-self-pitch control.

### TECHNICAL FIELD

The present disclosure relates to fluid turbine rotor blades of a particular structure, and more specifically, to a rotor blade design comprising aerodynamic pitch control, also known as self-pitch control or passive-pitch control.

### BACKGROUND

Horizontal-axis wind turbines are typically comprised of two to five bladed rotors joined at a central hub. Wind turbines have three general modes of operation: below rated wind speed; within the margin of rated wind speed; and above rated wind speed. As rated wind speed is exceeded, it becomes necessary to limit the rotational velocity of the rotor to prevent damage to electrical-generation components.

Common methods for limiting rotational velocity of a rotor include passive or mechanically actuated blade-pitch control and stall-regulated rotor blades. Both methods decrease angle of attack and induced drag. Actuated blade-pitch control, or “furling the blades,” employs mechanical means to rotate the blades on their long axis. Furling the blades decreases the angle of attack, which reduces induced drag from lift over the rotor blades. It also reduces the frontal cross-section of the rotor. Passive regulation involves the use of forces present in the environment to pitch the blades. Some passive methods act against a spring; others act against blade-deformation. Stall-regulated blades increase the angle of attack at which the relative wind strikes the rotor blades. A stall-regulated blade can be designed to stall passively in excessive wind speeds, however the frontal cross-section increases and therefore the absolute drag increases dramatically.

A passive pitching blade will reduce the rotational velocity of the rotor while reducing drag. Mechanisms of self-pitching rotor blades of the prior art comprise spring and/or weighted balance systems. There is a need for an airfoil design that will accomplish passive-pitching without the complexity associated with moving parts that make up spring loaded and/or weighted mechanisms.

### SUMMARY

A fluid turbine has a rotor blade design that comprises aerodynamic pitch control (also known as self-pitch control or passive-pitch control). A high operating lift coefficient (Cl), combined with high operating efficiency as a ratio of lift over drag (L/D/) provides sufficient pitching moment (Cm) to pitch the rotor blade and mitigate rotor over-speed in excessive winds. The aerodynamic properties of the airfoil design comprise laminar- and turbulent-flow effects that provide roughness insensitivity. Some embodiments comprise hybrid-actuated-self-pitch control.

Increased rotor power and efficiency as a product of the high Cl and L/D, in combination with the aerodynamic design of a ringed airfoil, provides significant benefits in sometimes highly variable incoming fluid-stream velocity levels.

One embodiment of the present disclosure is a turbine rotor with a ringed airfoil. Fluid turbines surrounded by a ringed airfoil offer increased rotor performance when compared to similar open rotors. The ringed airfoil has an inlet or leading edge and an exit or trailing edge, with the lift or suction side of the airfoil on the interior of the ring. Compared to an open rotor, which is an impediment in a fluid stream, a ringed airfoil increases fluid velocity over the lift surface of the airfoil. The fluid stream is divided into a low pressure/high velocity stream on the interior of the airfoil, and a high pressure/lower velocity stream on its exterior. The high-velocity fluid stream in the ringed airfoil's interior makes a rotor plane that has a greater unit-mass flow rate than that of an open rotor.

A rotor in a ducted turbine has a smaller diameter and operates under a higher mass-flow rate, at a higher resultant speed, than an open rotor of similar power-production potential. A comparatively smaller rotor diameter per unit-mass flow-rate obviates the structural factors of the open rotor. The relatively shorter blade may be produced with less costly materials while maintaining appropriate structure to operate at the relatively higher lift coefficient and efficiency factor than that of an open rotor of similar power-extraction potential. Although the aerodynamic features of the present embodiment are relevant to any fluid turbine rotor airfoil, specific structural aspects of rotors in ducted turbines benefit significantly.

The airfoil may be designed for minimal self-pitching in wind speeds approaching the turbine's rated wind-speed and maximum self-pitching in wind speeds above the rated wind speed of the turbine. Self-pitching characteristics may be designed to provide protection from wind gusts that exceed the operable range of the turbine, and as a fail-safe to mitigate rotor over-speed in excessive wind velocities.

One skilled in the art understands that a rotor with self-pitch characteristics may be used in conjunction with actuated pitch-control mechanisms. This is referred to as a hybrid passive-active pitch system. A hybrid passive-active pitch system provides increased blade-pitch reaction time and reduced torque requirements and energy usage required to pitch the rotor blades. The passive features provide a fail-safe, particularly in the event of a loss of grid power or other factors contributing to a loss of blade-pitch control.

As understood by one skilled in the art, the aerodynamic principles the present disclosure are not restricted to a specific fluid, and may apply to any fluid, defined as any liquid, gas or combination thereof and therefore includes water as well as air. In other words, the aerodynamic principles of a mixer ejector wind turbine apply to hydrodynamic principles in a mixer ejector water turbine.

### BRIEF DESCRIPTION OF THE DRAWINGS

FIG. 1 is an orthographic, side view of an example airfoil cross-section.

FIG. 2 is a graphic depiction of performance as a measure of coefficient of lift vs. the angle of attack of the airfoil of FIG. 1.

FIG. 3 is a graphic depiction of performance as a measure of lift over drag ratio vs. angle of attack of the airfoil of FIG. 1.

FIG. 4 is a graphic depiction of the performance as a measure of lift coefficient vs. drag coefficient of the airfoil of FIG. 1.

FIG. 5 is a graphic depiction of the performance as a measure of the pitching moment coefficient vs. the angle of attack of the airfoil of FIG. 1.

FIG. 6 is an orthographic, side view of an additional example airfoil cross-section of the present embodiment.

FIG. 7 is a graphic depiction of performance as a measure of coefficient of lift vs. angle of attack of the airfoil of FIG. 6.

FIG. 8 is a graphic depiction of performance as a measure of lift over drag ratio vs. angle of attack of the airfoil of FIG. 6.

FIG. 9 is a graphic depiction of performance as a measure of lift coefficient vs. drag coefficient of the airfoil of FIG. 6.

FIG. 10 is a graphic depiction of performance as a measure of the pitching moment coefficient vs. the angle of attack of the airfoil of FIG. 6.

FIG. 11 is an orthographic, side view of an additional example airfoil cross-section of the present embodiment.

FIG. 12 is a graphic depiction of performance as a measure of coefficient of lift vs. angle of attack of the airfoil of FIG. 11.

FIG. 13 is a graphic depiction of performance as a measure of lift over drag ratio vs. angle of attack of the airfoil of FIG. 11.

FIG. 14 is a graphic depiction of performance as a measure of lift coefficient vs. drag coefficient of the airfoil of FIG. 11.

FIG. 15 is a graphic depiction of performance as a measure of pitching moment coefficient vs. angle of attack of the airfoil of FIG. 11.

### DETAILED DESCRIPTION

The term “rotor” is used herein to refer to any assembly in which one or more blades or blade segments are attached to a shaft and rotate(s), enabling generation or extraction of power or energy from fluid flow rotating the blade(s) or blade segments. Any type of rotor that is understood by one skilled in the art, including conventional propeller-like rotors, rotor/stator assemblies, or multi-segment propeller-like rotors, may be associated with the ringed airfoil of the present disclosure. As used herein, the term “blade” encompasses any aspect of suitable blades, including those having multiple, associated blade segments.

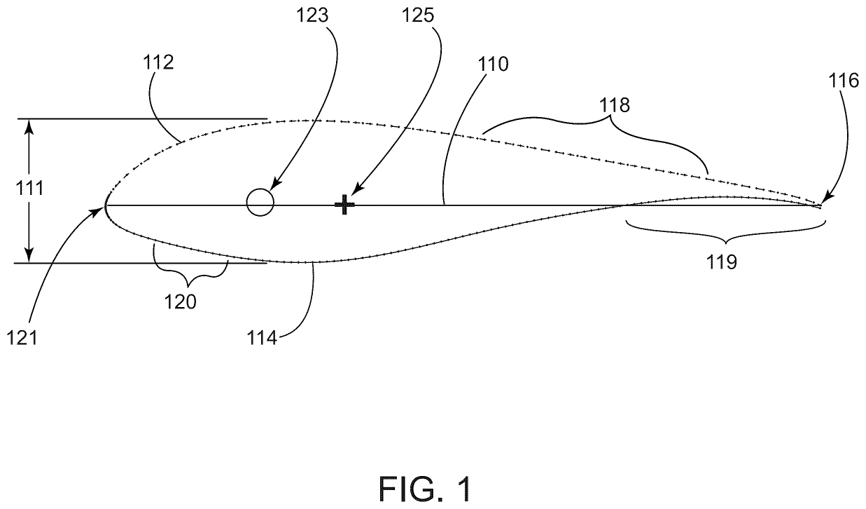

In FIG. 1 an airfoil 100 cross-section comprises a chord length 110 and a thickness represented by a distance 111. The ratio between the chord length 110 and the thickness 111 is approximately 18%; the thickness 111 is approximately 18% of the chord length 110. The airfoil cross-section further comprises an upper, “lift” surface 112 that resides above the chord 110 and extends from the leading edge 121 to the trailing edge 116 and a lower, “pressure” surface 114 a majority of which resides below the chord from the leading edge 121 to the trailing edge 116. Between 19% and 21% and in some embodiments, approximately 20% of the lower surface 114 proximal to the trailing edge 116, resides above the chord and is represented by segment 119. The airfoil cross-section is generally formed of continuously changing and transitioning radii having a portion of minimal curvature (in short, a substantially flat portion) on the upper surface in the region indicated by 118, and a substantially flat portion in the lower surface (region 120). A pivot point 123, about which the airfoil pitching moment is calculated, is located proximal to the chord 110 and between the leading edge 121 and the center of pressure 125 of the airfoil. The distance from the leading edge to the pivot point is in the area of ¼ the length of the chord. The center of pressure is a point in the airfoil cross-section where forces resulting from the pressure distribution yield no pitching moment. The center of pressure is generally proximal to the chord about ⅓ the distance from the leading edge 121 to the trailing edge 116.

The shape of the airfoil exhibits a high lift-coefficient and a relatively high pitch-moment coefficient as a result of relatively high camber downstream of the airfoil's center of pressure 125. The aft camber provides aft loading from the pressure distribution in the region proximal to the trailing edge 116. Self-pitching of the airfoil is a product of the pressure distribution and contributing aft-loading combined with pivot-point location. Movement of the pivot point 121 closer to the airfoil's center of pressure 125 decreases the pitch-moment coefficient, while movement of the pivot point 123 closer to the leading edge 121 increases the pitch-moment coefficient.

The specific geometric characteristics of the airfoil illustrated in FIG. 1 are given in the form of the following table of coordinates.

| Upper Surface 101P | | Lower Surface 101P | |
|---|---|---|---|
| 0.0000E+00 | 0.0000E+00 | 0.0000E+00 | 0.0000E+00 |
| 1.0294E−04 | 1.9828E−03 | 2.2136E−05 | −9.4450E−04 |
| 3.3487E−04 | 3.5842E−03 | 1.7026E−04 | −2.6172E−03 |
| 6.9538E−04 | 5.1824E−03 | 4.4564E−04 | −4.2274E−03 |
| 1.1781E−03 | 6.7752E−03 | 8.4872E−04 | −5.8200E−03 |
| 1.7774E−03 | 8.3666E−03 | 1.3805E−03 | −7.3994E−03 |
| 2.4888E−03 | 9.9621E−03 | 2.0463E−03 | −8.9732E−03 |
| 3.3132E−03 | 1.1575E−02 | 2.8507E−03 | −1.0542E−02 |
| 4.2551E−03 | 1.3219E−02 | 3.7974E−03 | −1.2101E−02 |
| 5.3209E−03 | 1.4908E−02 | 4.8849E−03 | −1.3640E−02 |
| 7.8566E−03 | 1.8460E−02 | 7.4893E−03 | −1.6650E−02 |
| 1.0999E−02 | 2.2311E−02 | 1.0723E−02 | −1.9591E−02 |
| 1.4856E−02 | 2.6535E−02 | 1.4683E−02 | −2.2489E−02 |
| 2.0010E−02 | 3.1624E−02 | 1.9990E−02 | −2.5630E−02 |
| 3.0016E−02 | 4.0307E−02 | 2.9984E−02 | −3.0226E−02 |
| 4.0021E−02 | 4.7867E−02 | 3.9979E−02 | −3.3859E−02 |
| 5.0026E−02 | 5.4558E−02 | 4.9974E−02 | −3.6955E−02 |
| 6.0031E−02 | 6.0525E−02 | 5.9969E−02 | −3.9725E−02 |
| 7.0037E−02 | 6.5874E−02 | 6.9963E−02 | −4.2281E−02 |
| 8.0042E−02 | 7.0687E−02 | 7.9958E−02 | −4.4686E−02 |
| 9.0047E−02 | 7.5033E−02 | 8.9953E−02 | −4.6974E−02 |
| 1.0005E−01 | 7.8971E−02 | 9.9948E−02 | −4.9164E−02 |
| 1.1006E−01 | 8.2549E−02 | 1.0994E−01 | −5.1264E−02 |
| 1.2006E−01 | 8.5809E−02 | 1.1994E−01 | −5.3278E−02 |
| 1.3007E−01 | 8.8782E−02 | 1.2993E−01 | −5.5204E−02 |
| 1.4007E−01 | 9.1496E−02 | 1.3993E−01 | −5.7039E−02 |
| 1.5008E−01 | 9.3972E−02 | 1.4992E−01 | −5.8780E−02 |
| 1.6008E−01 | 9.6225E−02 | 1.5992E−01 | −6.0422E−02 |
| 1.7009E−01 | 9.8270E−02 | 1.6991E−01 | −6.1958E−02 |
| 1.8009E−01 | 1.0011E−01 | 1.7991E−01 | −6.3384E−02 |
| 1.9010E−01 | 1.0177E−01 | 1.8990E−01 | −6.4693E−02 |
| 2.0010E−01 | 1.0324E−01 | 1.9990E−01 | −6.5880E−02 |
| 2.1011E−01 | 1.0452E−01 | 2.0989E−01 | −6.6938E−02 |
| 2.2012E−01 | 1.0563E−01 | 2.1988E−01 | −6.7861E−02 |
| 2.3012E−01 | 1.0657E−01 | 2.2988E−01 | −6.8644E−02 |
| 2.4013E−01 | 1.0734E−01 | 2.3987E−01 | −6.9282E−02 |
| 2.5013E−01 | 1.0795E−01 | 2.4987E−01 | −6.9770E−02 |
| 2.6014E−01 | 1.0840E−01 | 2.5986E−01 | −7.0103E−02 |
| 2.7014E−01 | 1.0869E−01 | 2.6986E−01 | −7.0277E−02 |
| 2.8015E−01 | 1.0884E−01 | 2.7985E−01 | −7.0290E−02 |
| 2.9015E−01 | 1.0885E−01 | 2.8985E−01 | −7.0140E−02 |
| 3.0016E−01 | 1.0873E−01 | 2.9984E−01 | −6.9825E−02 |
| 3.1016E−01 | 1.0848E−01 | 3.0984E−01 | −6.9346E−02 |
| 3.2017E−01 | 1.0812E−01 | 3.1983E−01 | −6.8704E−02 |
| 3.3017E−01 | 1.0764E−01 | 3.2983E−01 | −6.7902E−02 |
| 3.4018E−01 | 1.0707E−01 | 3.3982E−01 | −6.6943E−02 |
| 3.5018E−01 | 1.0640E−01 | 3.4982E−01 | −6.5832E−02 |
| 3.6019E−01 | 1.0564E−01 | 3.5981E−01 | −6.4577E−02 |
| 3.7019E−01 | 1.0481E−01 | 3.6981E−01 | −6.3183E−02 |
| 3.8020E−01 | 1.0390E−01 | 3.7980E−01 | −6.1661E−02 |
| 3.9020E−01 | 1.0293E−01 | 3.8980E−01 | −6.0018E−02 |
| 4.0021E−01 | 1.0189E−01 | 3.9979E−01 | −5.8267E−02 |
| 4.1021E−01 | 1.0081E−01 | 4.0979E−01 | −5.6417E−02 |
| 4.2022E−01 | 9.9675E−02 | 4.1978E−01 | −5.4481E−02 |
| 4.3023E−01 | 9.8496E−02 | 4.2977E−01 | −5.2471E−02 |
| 4.4023E−01 | 9.7277E−02 | 4.3977E−01 | −5.0399E−02 |
| 4.5024E−01 | 9.6021E−02 | 4.4976E−01 | −4.8278E−02 |
| 4.6024E−01 | 9.4731E−02 | 4.5976E−01 | −4.6120E−02 |
| 4.7025E−01 | 9.3408E−02 | 4.6975E−01 | −4.3937E−02 |
| 4.8025E−01 | 9.2056E−02 | 4.7975E−01 | −4.1741E−02 |
| 4.9026E−01 | 9.0676E−02 | 4.8974E−01 | −3.9542E−02 |
| 5.0026E−01 | 8.9270E−02 | 4.9974E−01 | −3.7351E−02 |
| 5.1027E−01 | 8.7838E−02 | 5.0973E−01 | −3.5178E−02 |
| 5.2027E−01 | 8.6383E−02 | 5.1973E−01 | −3.3029E−02 |
| 5.3028E−01 | 8.4904E−02 | 5.2972E−01 | −3.0913E−02 |
| 5.4028E−01 | 8.3405E−02 | 5.3972E−01 | −2.8835E−02 |
| 5.5029E−01 | 8.1885E−02 | 5.4971E−01 | −2.6800E−02 |
| 5.6029E−01 | 8.0347E−02 | 5.5971E−01 | −2.4812E−02 |
| 5.7030E−01 | 7.8792E−02 | 5.6970E−01 | −2.2873E−02 |
| 5.8030E−01 | 7.7221E−02 | 5.7970E−01 | −2.0985E−02 |
| 5.9031E−01 | 7.5637E−02 | 5.8969E−01 | −1.9148E−02 |
| 6.0031E−01 | 7.4040E−02 | 5.9969E−01 | −1.7361E−02 |
| 6.1032E−01 | 7.2434E−02 | 6.0968E−01 | −1.5624E−02 |
| 6.2032E−01 | 7.0821E−02 | 6.1968E−01 | −1.3934E−02 |
| 6.3033E−01 | 6.9202E−02 | 6.2967E−01 | −1.2288E−02 |
| 6.4033E−01 | 6.7579E−02 | 6.3967E−01 | −1.0686E−02 |
| 6.5034E−01 | 6.5954E−02 | 6.4966E−01 | −9.1221E−03 |
| 6.6035E−01 | 6.4330E−02 | 6.5965E−01 | −7.5958E−03 |
| 6.7035E−01 | 6.2707E−02 | 6.6965E−01 | −6.1041E−03 |
| 6.8036E−01 | 6.1088E−02 | 6.7964E−01 | −4.6455E−03 |
| 6.9036E−01 | 5.9472E−02 | 6.8964E−01 | −3.2189E−03 |
| 7.0037E−01 | 5.7861E−02 | 6.9963E−01 | −1.8240E−03 |
| 7.1037E−01 | 5.6254E−02 | 7.0963E−01 | −4.6167E−04 |
| 7.2038E−01 | 5.4652E−02 | 7.1962E−01 | 8.6637E−04 |
| 7.3038E−01 | 5.3054E−02 | 7.2962E−01 | 2.1571E−03 |
| 7.4039E−01 | 5.1458E−02 | 7.3961E−01 | 3.4064E−03 |
| 7.5039E−01 | 4.9864E−02 | 7.4961E−01 | 4.6091E−03 |
| 7.6040E−01 | 4.8269E−02 | 7.5960E−01 | 5.7586E−03 |
| 7.7040E−01 | 4.6672E−02 | 7.6960E−01 | 6.8477E−03 |
| 7.8041E−01 | 4.5071E−02 | 7.7959E−01 | 7.8683E−03 |
| 7.9041E−01 | 4.3464E−02 | 7.8959E−01 | 8.8114E−03 |
| 8.0042E−01 | 4.1849E−02 | 7.9958E−01 | 9.6679E−03 |
| 8.1042E−01 | 4.0224E−02 | 8.0958E−01 | 1.0429E−02 |
| 8.2043E−01 | 3.8589E−02 | 8.1957E−01 | 1.1084E−02 |
| 8.3043E−01 | 3.6942E−02 | 8.2957E−01 | 1.1626E−02 |
| 8.4044E−01 | 3.5283E−02 | 8.3956E−01 | 1.2046E−02 |
| 8.5044E−01 | 3.3613E−02 | 8.4956E−01 | 1.2337E−02 |
| 8.6045E−01 | 3.1931E−02 | 8.5955E−01 | 1.2495E−02 |
| 8.7046E−01 | 3.0238E−02 | 8.6954E−01 | 1.2514E−02 |
| 8.8046E−01 | 2.8535E−02 | 8.7954E−01 | 1.2392E−02 |
| 8.9047E−01 | 2.6820E−02 | 8.8953E−01 | 1.2128E−02 |
| 9.0047E−01 | 2.5091E−02 | 8.9953E−01 | 1.1721E−02 |
| 9.1048E−01 | 2.3343E−02 | 9.0952E−01 | 1.1172E−02 |
| 9.2048E−01 | 2.1567E−02 | 9.1952E−01 | 1.0480E−02 |
| 9.3049E−01 | 1.9746E−02 | 9.2951E−01 | 9.6439E−03 |
| 9.4049E−01 | 1.7857E−02 | 9.3951E−01 | 8.6584E−03 |
| 9.5050E−01 | 1.5864E−02 | 9.4950E−01 | 7.5129E−03 |
| 9.6050E−01 | 1.3718E−02 | 9.5950E−01 | 6.1883E−03 |
| 9.7051E−01 | 1.1348E−02 | 9.6949E−01 | 4.6536E−03 |
| 9.8051E−01 | 8.6612E−03 | 9.7949E−01 | 2.8613E−03 |
| 9.9052E−01 | 5.5329E−03 | 9.8948E−01 | 7.4221E−04 |
| 1.0005E+00 | 1.8014E−03 | 9.9948E−01 | −1.8014E−03 |

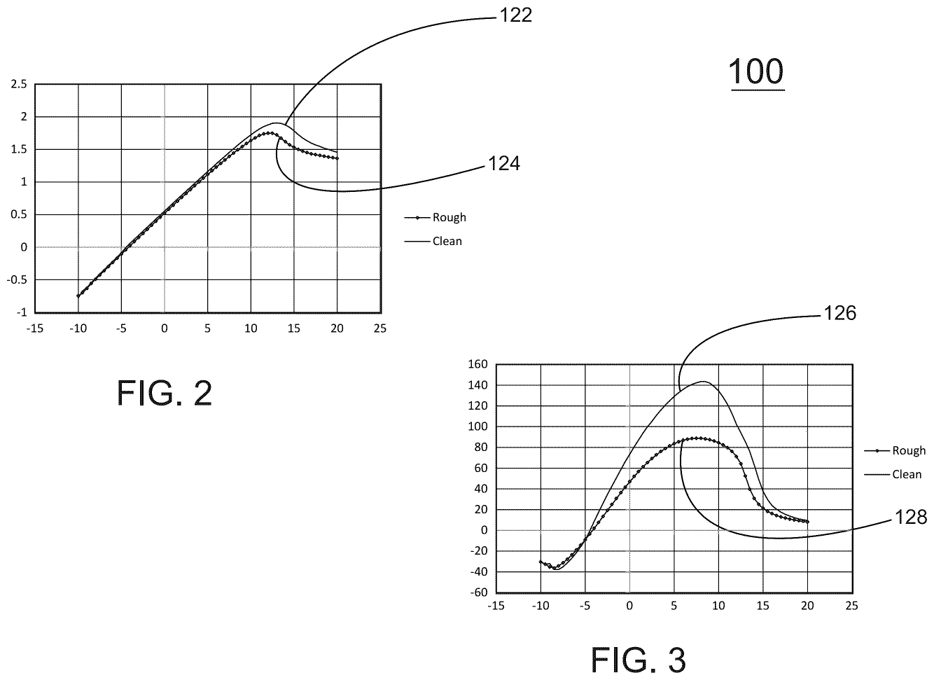

FIG. 2 shows the airfoil's 100 performance as a product of the coefficient of lift along the vertical axis, and the angle of attack along the horizontal axis. Data points along curve 122 represent the performance of the airfoil 100 with a clean surface. Data points along the curve 124 represent the performance of the airfoil 100 with a rough surface as would occur when environmental debris collects on the surface of a rotor blade, resulting in higher turbulence. Given the higher maximum lift coefficient, the operating lift coefficient can be approximately 1.3 for both clean and rough surfaces.

FIG. 3 depicts the efficiency of the airfoil 100 as a product of the coefficient of lift over drag (L/D) along the vertical axis and the angle of attack (AoA) along the horizontal axis. Data points along curve 126 represent the efficiency of the airfoil 100 with a clean surface. Data points along the curve 128 represent the efficiency of the airfoil 100 with a rough surface as would occur when environmental debris collects on the surface of a rotor blade, resulting in higher turbulence. The maximum L/D over a clean surface can reach approximately 143 and approximately 88 over a rough surface.

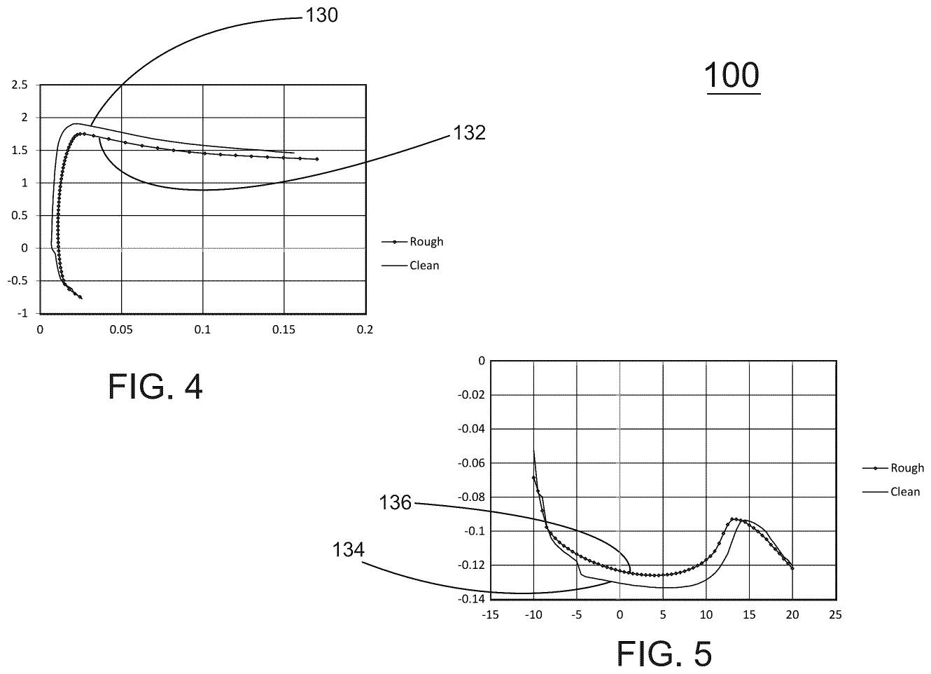

FIG. 4 depicts the performance of the airfoil 100 as a product of the lift coefficient (Cl) along the vertical axis and the drag coefficient (Cd) along the horizontal axis. Data points along curve 130 represent the performance of the airfoil 100 with a clean surface. Data points along the curve 132 represent the performance of the airfoil 100 with a rough surface as would occur when environmental debris collects on the surface of a rotor blade, resulting in higher turbulence. The lift coefficient and drag coefficient of the airfoil described in FIG. 1 are contributing factors to the substantial insensitivity to surface texturing.

FIG. 5 depicts the performance of the airfoil 100 as a product of the pitch moment coefficient (Cm) along the vertical axis and the angle of attack (AoA) along the horizontal axis. Data points along curve 134 represent the performance of the airfoil 100 with a clean surface. Data points along the curve 136 represent the performance of the airfoil 100 with a rough surface as would occur when environmental debris collects on the surface of a rotor blade. This shows the pitching performance as a product of a relatively high absolute self-pitch moment coefficient.

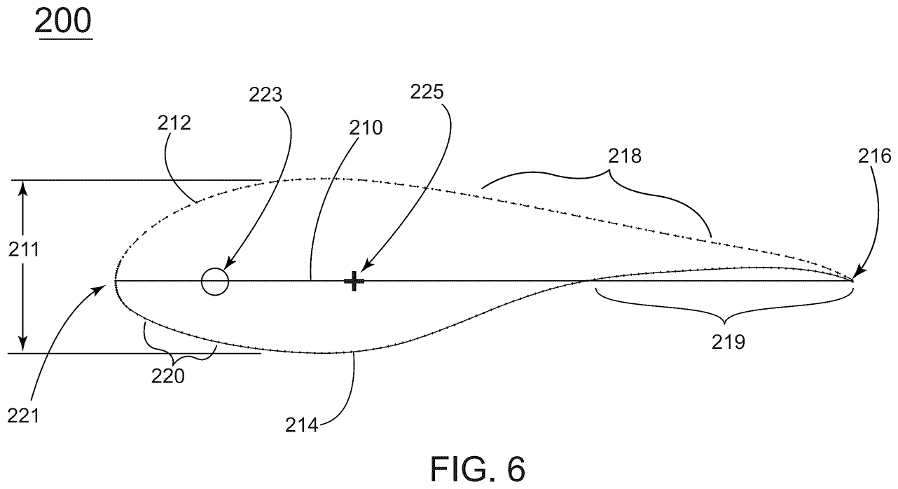

FIG. 6 shows an example airfoil 200 in section view. The airfoil cross-section comprises a chord length 210 and a thickness represented by distance 211. The ratio between the chord length 210 and the thickness 211 is approximately 21%. The airfoil cross-section has an upper surface 212 that resides above the chord 210 and extends from the leading edge 221 to the trailing edge 216, and a lower surface that resides substantially below the chord, from the leading edge 221 to the trailing edge 216 with a portion of the lower surface residing above the chord. Between 34% and 38%, and in some embodiments, approximately 35.7%, of the lower surface 214 near the trailing edge 216, resides above the chord and is represented by segment 219. The airfoil cross-section is generally formed of continuously changing and transitioning radii having a portion of minimal curvature, i.e., a substantially flat portion, on the upper surface (region 218), and a substantially flat portion in the lower surface (region 220). A pivot point 223 about which the airfoil pitching moment is calculated, is located proximal to the chord 210 and between the leading edge 221 and the center of pressure 225 of the airfoil. The distance from the leading edge to the pivot point is in the area of ¼ the length of the chord. The center of pressure is a point in the airfoil cross-section where forces resulting from the pressure distribution yields no pitching moment. The center of pressure is generally proximal to the chord about ⅓ the distance from the leading edge 221 to the trailing edge 216.

The shape of the airfoil exhibits a high lift coefficient and a relatively high pitch-moment coefficient as a result of relatively high camber downstream of the airfoil's center of pressure 225. The aft camber provides aft-loading from the pressure distribution in the region proximal to the trailing edge 216. Self-pitching of the airfoil is a product of the pressure distribution and contributing aft-loading combined with the pivot-point location. Movement of the pivot point 221 closer to the airfoil's center of pressure 225 decreases the pitch-moment coefficient, while movement of the pivot point 223 closer to the leading edge 221 increases the pitch-moment coefficient.

The specific geometric characteristics of the airfoil illustrated in FIG. 6 are given in the form of the following table of coordinates.

| Upper Surface 101P | | Lower Surface 101P | |
|---|---|---|---|
| 0.0000E+00 | 0.0000E+00 | 0.0000E+00 | 0.0000E+00 |
| 1.7414E−04 | 3.6975E−03 | 7.7634E−05 | −2.4515E−03 |
| 5.8132E−04 | 6.7602E−03 | 3.4299E−04 | −5.1414E−03 |
| 1.1445E−03 | 9.4941E−03 | 8.3229E−04 | −7.9764E−03 |
| 1.8448E−03 | 1.2067E−02 | 1.5465E−03 | −1.0809E−02 |
| 2.7117E−03 | 1.4649E−02 | 2.4363E−03 | −1.3469E−02 |
| 3.7658E−03 | 1.7290E−02 | 3.4819E−03 | −1.5968E−02 |
| 5.0043E−03 | 1.9966E−02 | 4.6744E−03 | −1.8330E−02 |
| 6.4334E−03 | 2.2681E−02 | 5.9971E−03 | −2.0556E−02 |
| 1.0020E−02 | 2.8428E−02 | 7.4410E−03 | −2.2655E−02 |
| 1.4279E−02 | 3.4084E−02 | 1.0755E−02 | −2.6616E−02 |
| 2.0000E−02 | 4.0527E−02 | 1.4812E−02 | −3.0439E−02 |
| 3.0000E−02 | 4.9906E−02 | 2.0000E−02 | −3.4342E−02 |
| 4.0000E−02 | 5.7779E−02 | 3.0000E−02 | −4.0138E−02 |
| 5.0000E−02 | 6.4627E−02 | 4.0000E−02 | −4.4726E−02 |
| 6.0000E−02 | 7.0703E−02 | 5.0000E−02 | −4.8675E−02 |
| 7.0000E−02 | 7.6161E−02 | 6.0000E−02 | −5.2239E−02 |
| 8.0000E−02 | 8.1107E−02 | 7.0000E−02 | −5.5530E−02 |
| 9.0000E−02 | 8.5616E−02 | 8.0000E−02 | −5.8599E−02 |
| 1.0000E−01 | 8.9744E−02 | 9.0000E−02 | −6.1466E−02 |
| 1.1000E−01 | 9.3534E−02 | 1.0000E−01 | −6.4136E−02 |
| 1.2000E−01 | 9.7018E−02 | 1.1000E−01 | −6.6613E−02 |
| 1.3000E−01 | 1.0022E−01 | 1.2000E−01 | −6.8899E−02 |
| 1.4000E−01 | 1.0316E−01 | 1.3000E−01 | −7.1001E−02 |
| 1.5000E−01 | 1.0585E−01 | 1.4000E−01 | −7.2925E−02 |
| 1.6000E−01 | 1.0831E−01 | 1.5000E−01 | −7.4683E−02 |
| 1.7000E−01 | 1.1054E−01 | 1.6000E−01 | −7.6285E−02 |
| 1.8000E−01 | 1.1255E−01 | 1.7000E−01 | −7.7745E−02 |
| 1.9000E−01 | 1.1435E−01 | 1.8000E−01 | −7.9072E−02 |
| 2.0000E−01 | 1.1594E−01 | 1.9000E−01 | −8.0277E−02 |
| 2.1000E−01 | 1.1732E−01 | 2.0000E−01 | −8.1367E−02 |
| 2.2000E−01 | 1.1851E−01 | 2.1000E−01 | −8.2348E−02 |
| 2.3000E−01 | 1.1950E−01 | 2.2000E−01 | −8.3222E−02 |
| 2.4000E−01 | 1.2030E−01 | 2.3000E−01 | −8.3987E−02 |
| 2.5000E−01 | 1.2093E−01 | 2.4000E−01 | −8.4640E−02 |
| 2.6000E−01 | 1.2137E−01 | 2.5000E−01 | −8.5173E−02 |
| 2.7000E−01 | 1.2165E−01 | 2.6000E−01 | −8.5577E−02 |
| 2.8000E−01 | 1.2176E−01 | 2.7000E−01 | −8.5840E−02 |
| 2.9000E−01 | 1.2172E−01 | 2.8000E−01 | −8.5949E−02 |
| 3.0000E−01 | 1.2153E−01 | 2.9000E−01 | −8.5891E−02 |
| 3.1000E−01 | 1.2120E−01 | 3.0000E−01 | −8.5650E−02 |
| 3.2000E−01 | 1.2074E−01 | 3.1000E−01 | −8.5214E−02 |
| 3.3000E−01 | 1.2016E−01 | 3.2000E−01 | −8.4568E−02 |
| 3.4000E−01 | 1.1947E−01 | 3.3000E−01 | −8.3703E−02 |
| 3.5000E−01 | 1.1868E−01 | 3.4000E−01 | −8.2608E−02 |
| 3.6000E−01 | 1.1779E−01 | 3.5000E−01 | −8.1277E−02 |
| 3.7000E−01 | 1.1681E−01 | 3.6000E−01 | −7.9706E−02 |
| 3.8000E−01 | 1.1576E−01 | 3.7000E−01 | −7.7894E−02 |
| 3.9000E−01 | 1.1463E−01 | 3.8000E−01 | −7.5844E−02 |
| 4.0000E−01 | 1.1344E−01 | 3.9000E−01 | −7.3562E−02 |
| 4.1000E−01 | 1.1219E−01 | 4.0000E−01 | −7.1056E−02 |
| 4.2000E−01 | 1.1088E−01 | 4.1000E−01 | −6.8342E−02 |
| 4.3000E−01 | 1.0953E−01 | 4.2000E−01 | −6.5433E−02 |
| 4.4000E−01 | 1.0814E−01 | 4.3000E−01 | −6.2350E−02 |
| 4.5000E−01 | 1.0671E−01 | 4.4000E−01 | −5.9115E−02 |
| 4.6000E−01 | 1.0525E−01 | 4.5000E−01 | −5.5750E−02 |
| 4.7000E−01 | 1.0375E−01 | 4.6000E−01 | −5.2283E−02 |
| 4.8000E−01 | 1.0223E−01 | 4.7000E−01 | −4.8739E−02 |
| 4.9000E−01 | 1.0068E−01 | 4.8000E−01 | −4.5148E−02 |
| 5.0000E−01 | 9.9104E−02 | 4.9000E−01 | −4.1537E−02 |
| 5.1000E−01 | 9.7507E−02 | 5.0000E−01 | −3.7934E−02 |
| 5.2000E−01 | 9.5889E−02 | 5.1000E−01 | −3.4367E−02 |
| 5.3000E−01 | 9.4250E−02 | 5.2000E−01 | −3.0861E−02 |
| 5.4000E−01 | 9.2592E−02 | 5.3000E−01 | −2.7441E−02 |
| 5.5000E−01 | 9.0915E−02 | 5.4000E−01 | −2.4129E−02 |
| 5.6000E−01 | 8.9219E−02 | 5.5000E−01 | −2.0945E−02 |
| 5.7000E−01 | 8.7507E−02 | 5.6000E−01 | −1.7906E−02 |
| 5.8000E−01 | 8.5778E−02 | 5.7000E−01 | −1.5025E−02 |
| 5.9000E−01 | 8.4033E−02 | 5.8000E−01 | −1.2313E−02 |
| 6.0000E−01 | 8.2274E−02 | 5.9000E−01 | −9.7786E−03 |
| 6.1000E−01 | 8.0502E−02 | 6.0000E−01 | −7.4244E−03 |
| 6.2000E−01 | 7.8718E−02 | 6.1000E−01 | −5.2517E−03 |
| 6.3000E−01 | 7.6925E−02 | 6.2000E−01 | −3.2585E−03 |
| 6.4000E−01 | 7.5125E−02 | 6.3000E−01 | −1.4394E−03 |
| 6.5000E−01 | 7.3319E−02 | 6.4000E−01 | 2.1306E−04 |
| 6.6000E−01 | 7.1510E−02 | 6.5000E−01 | 1.7089E−03 |
| 6.7000E−01 | 6.9701E−02 | 6.6000E−01 | 3.0599E−03 |
| 6.8000E−01 | 6.7895E−02 | 6.7000E−01 | 4.2793E−03 |
| 6.9000E−01 | 6.6094E−02 | 6.8000E−01 | 5.3810E−03 |
| 7.0000E−01 | 6.4301E−02 | 6.9000E−01 | 6.3797E−03 |
| 7.1000E−01 | 6.2519E−02 | 7.0000E−01 | 7.2897E−03 |
| 7.2000E−01 | 6.0751E−02 | 7.1000E−01 | 8.1251E−03 |
| 7.3000E−01 | 5.9000E−02 | 7.2000E−01 | 8.8988E−03 |
| 7.4000E−01 | 5.7267E−02 | 7.3000E−01 | 9.6223E−03 |
| 7.5000E−01 | 5.5555E−02 | 7.4000E−01 | 1.0305E−02 |
| 7.6000E−01 | 5.3865E−02 | 7.5000E−01 | 1.0955E−02 |
| 7.7000E−01 | 5.2199E−02 | 7.6000E−01 | 1.1578E−02 |
| 7.8000E−01 | 5.0555E−02 | 7.7000E−01 | 1.2176E−02 |
| 7.9000E−01 | 4.8935E−02 | 7.8000E−01 | 1.2750E−02 |
| 8.0000E−01 | 4.7336E−02 | 7.9000E−01 | 1.3298E−02 |
| 8.1000E−01 | 4.5756E−02 | 8.0000E−01 | 1.3815E−02 |
| 8.2000E−01 | 4.4191E−02 | 8.1000E−01 | 1.4295E−02 |
| 8.3000E−01 | 4.2636E−02 | 8.2000E−01 | 1.4730E−02 |
| 8.4000E−01 | 4.1084E−02 | 8.3000E−01 | 1.5111E−02 |
| 8.5000E−01 | 3.9528E−02 | 8.4000E−01 | 1.5426E−02 |
| 8.6000E−01 | 3.7957E−02 | 8.5000E−01 | 1.5667E−02 |
| 8.7000E−01 | 3.6359E−02 | 8.6000E−01 | 1.5820E−02 |
| 8.8000E−01 | 3.4717E−02 | 8.7000E−01 | 1.5877E−02 |
| 8.9000E−01 | 3.3016E−02 | 8.8000E−01 | 1.5826E−02 |
| 9.0000E−01 | 3.1233E−02 | 8.9000E−01 | 1.5657E−02 |
| 9.1000E−01 | 2.9343E−02 | 9.0000E−01 | 1.5362E−02 |
| 9.2000E−01 | 2.7317E−02 | 9.1000E−01 | 1.4928E−02 |
| 9.3000E−01 | 2.5121E−02 | 9.2000E−01 | 1.4344E−02 |
| 9.4000E−01 | 2.2714E−02 | 9.3000E−01 | 1.3592E−02 |
| 9.5000E−01 | 2.0049E−02 | 9.4000E−01 | 1.2647E−02 |
| 9.6000E−01 | 1.7071E−02 | 9.5000E−01 | 1.1475E−02 |
| 9.7000E−01 | 1.3715E−02 | 9.6000E−01 | 1.0025E−02 |
| 9.8000E−01 | 9.9061E−03 | 9.7000E−01 | 8.2225E−03 |
| 9.9000E−01 | 5.5555E−03 | 9.8000E−01 | 5.9637E−03 |
| 1.0000E+00 | 5.6022E−04 | 9.9000E−01 | 3.1025E−03 |
| | | 1.0000E+00 | −5.6022E−04 |

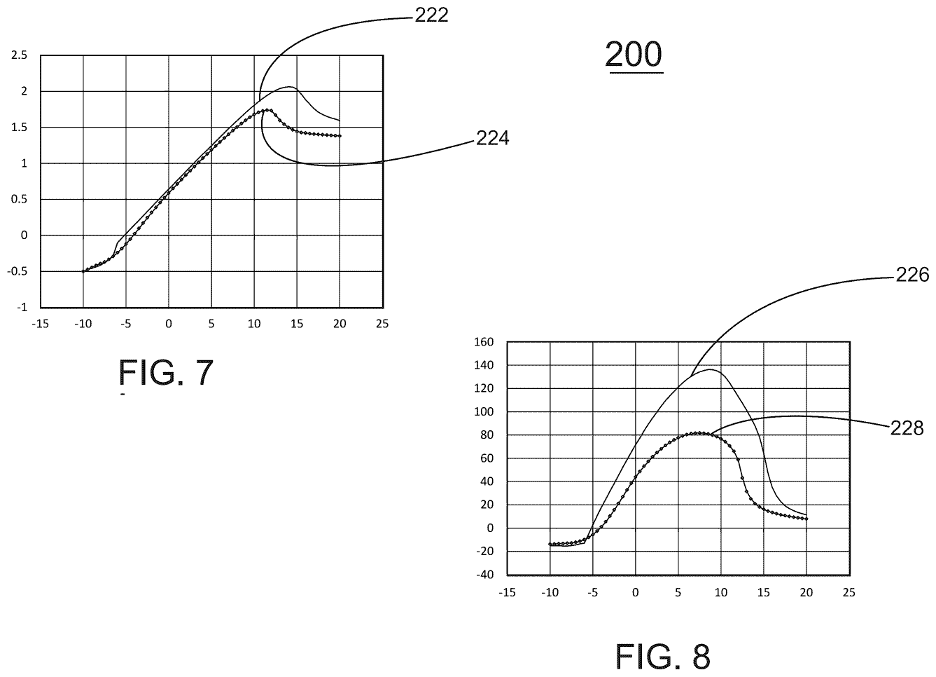

FIG. 7 depicts the performance of the airfoil 200 as a product of the coefficient of lift along the vertical axis and the angle of attack along the horizontal axis. Data points along curve 222 represent the performance of the airfoil 200 with a clean surface. Data points along the curve 224 represent the performance of the airfoil 200 with a rough surface as would occur when environmental debris collects on the surface of a rotor blade, resulting in higher turbulence. Given the higher maximum lift coefficient, the operating lift coefficient can be approximately 1.3 for both clean and rough surfaces.

FIG. 8 depicts the efficiency of the airfoil 200 as a product of the coefficient of lift over drag (L/D) along the vertical axis and the angle of attack (AoA) along the horizontal axis. Data points along curve 226 represent the efficiency of the airfoil 200 with a clean surface. Data points along the curve 228 represent the efficiency of the airfoil 200 with a rough surface as would occur when environmental debris collects on the surface of a rotor blade, resulting in higher turbulence. The maximum L/D over a clean surface can reach approximately 138 and approximately 81 over a rough surface.

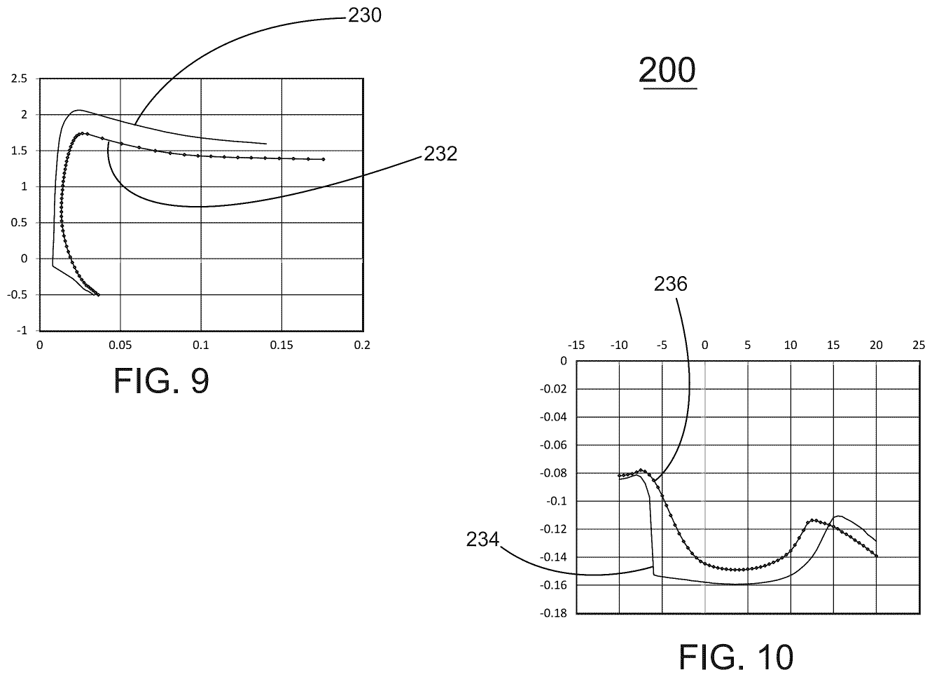

FIG. 9 depicts the performance of the airfoil 200 as a product of the lift coefficient (Cl) along the vertical axis and the drag coefficient (Cd) along the horizontal axis. Data points along curve 230 represent the performance of the airfoil 200 with a clean surface. Data points along the curve 232 represent the performance of the airfoil 200 with a rough surface, as would occur when environmental debris collects on the surface of a rotor blade, resulting in higher turbulence. The lift coefficient and drag coefficient of the airfoil described in FIG. 6 are contributing factors to the substantial insensitivity to surface texturing.

FIG. 10 depicts the performance of the airfoil 200 as a product of the pitch-moment coefficient (Cm) along the vertical axis and the angle of attack (AoA) along the horizontal axis. Data points along curve 234 represent the performance of the airfoil 200 with a clean surface. Data points along the curve 236 represent the performance of the airfoil 200 with a rough surface, as would occur when environmental debris collects on the surface of a rotor blade. This shows the pitching performance as a product of a relatively high absolute self-pitch moment coefficient.

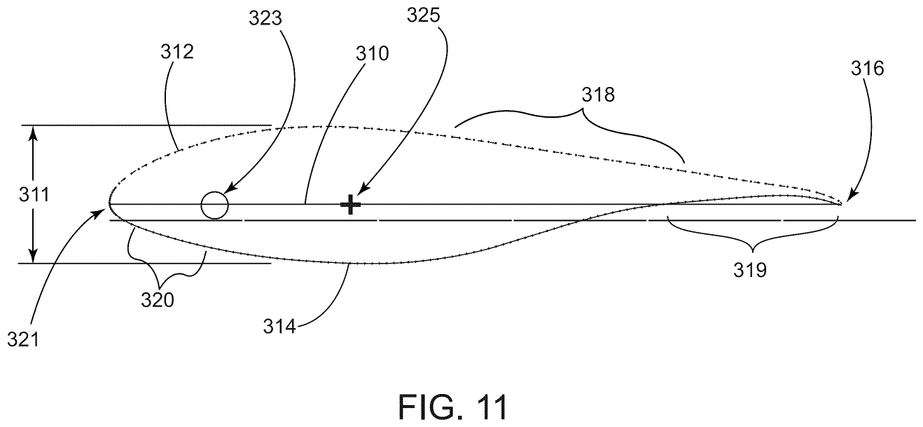

In FIG. 11, an example airfoil's 300 cross-section comprises a chord length 310 and a thickness represented by a distance 311. The ratio between the chord length 310 and the thickness 311 is approximately 18%. The airfoil cross-section further comprises an upper surface 312 that resides above the chord 310 and extends from the leading edge 321 to the trailing edge 316 and a lower surface 314 that resides below the chord from the leading edge 321 to the trailing edge 316 with a portion of the lower surface residing above the chord 319. Between 18.5% and 20.5% and in some embodiments, approximately 19.5%, of the lower surface 314 (referred to as a pressure surface), proximal to the trailing edge 316, resides above the chord and is represented by segment 319. The airfoil cross-section is generally formed of continuously changing and transitioning radii having a portion of minimal curvature (in short, a substantially flat portion), on the upper surface in region 318, and a substantially flat portion in the lower surface (region 320). A pivot point 323, about which the airfoil pitching moment is calculated, is located proximal to the chord 310 and between the leading edge 321 and the center of pressure 325 of the airfoil. The distance from the leading edge to the pivot point is in the area of ¼ the length of the chord. The center of pressure is a point in the airfoil cross-section where forces resulting from the pressure distribution yields no pitching moment. The center of pressure is generally proximal to the chord about ⅓ the distance form the leading edge 321 to the trailing edge 316.

The shape of the airfoil exhibits a high lift coefficient and a relatively high pitch-moment coefficient as a result of relatively high camber downstream of the center of pressure 325 of the airfoil. The aft camber provides aft-loading from the pressure distribution in the region proximal to the trailing edge 316. Self-pitching of the airfoil is a product of the pressure distribution and contributing aft-loading, combined with the pivot-point location. Movement of the pivot point 321 closer to the airfoil's center of pressure 325 decreases the pitch-moment coefficient, while movement of the pivot point 323 closer to the leading edge 321 increases the pitch-moment coefficient.

The specific geometric characteristics of the airfoil illustrated in FIG. 11 are given in the form of the following table of coordinates.

| Upper Surface 101P | | Lower Surface 101P | |
|---|---|---|---|
| 0.0000E+00 | 0.0000E+00 | 0.00000E+00 | 0.00000E+00 |
| 1.7114E−04 | 3.8069E−03 | 7.79584E−05 | −2.06736E−03 |
| 6.2150E−04 | 7.2573E−03 | 3.94491E−04 | −4.64553E−03 |
| 1.3842E−03 | 1.0836E−02 | 1.10821E−03 | −7.76639E−03 |
| 2.4289E−03 | 1.4363E−02 | 2.32409E−03 | −1.11980E−02 |
| 3.8483E−03 | 1.8093E−02 | 4.13169E−03 | −1.48365E−02 |
| 5.6101E−03 | 2.1864E−02 | 6.38815E−03 | −1.83093E−02 |
| 7.7721E−03 | 2.5759E−02 | 8.73237E−03 | −2.12481E−02 |
| 1.3256E−02 | 3.3709E−02 | 1.36266E−02 | −2.61700E−02 |
| 1.9972E−02 | 4.1455E−02 | 1.97003E−02 | −3.09958E−02 |
| 2.9998E−02 | 5.0903E−02 | 2.00015E−02 | −3.12107E−02 |
| 3.9997E−02 | 5.8847E−02 | 3.00022E−02 | −3.75008E−02 |
| 4.9996E−02 | 6.5834E−02 | 4.00029E−02 | −4.27306E−02 |
| 5.9996E−02 | 7.2133E−02 | 5.00036E−02 | −4.73674E−02 |
| 6.9995E−02 | 7.7901E−02 | 6.00044E−02 | −5.16352E−02 |
| 7.9994E−02 | 8.3237E−02 | 7.00051E−02 | −5.56500E−02 |
| 8.9993E−02 | 8.8206E−02 | 8.00058E−02 | −5.94710E−02 |
| 9.9993E−02 | 9.2850E−02 | 9.00066E−02 | −6.31267E−02 |
| 1.0999E−01 | 9.7198E−02 | 1.00007E−01 | −6.66275E−02 |
| 1.1999E−01 | 1.0127E−01 | 1.10008E−01 | −6.99745E−02 |
| 1.2999E−01 | 1.0507E−01 | 1.20009E−01 | −7.31639E−02 |
| 1.3999E−01 | 1.0862E−01 | 1.30009E−01 | −7.61905E−02 |
| 1.4999E−01 | 1.1191E−01 | 1.40010E−01 | −7.90491E−02 |
| 1.5999E−01 | 1.1495E−01 | 1.50011E−01 | −8.17364E−02 |
| 1.6999E−01 | 1.1773E−01 | 1.60012E−01 | −8.42509E−02 |
| 1.7999E−01 | 1.2027E−01 | 1.70012E−01 | −8.65936E−02 |
| 1.8999E−01 | 1.2256E−01 | 1.80013E−01 | −8.87676E−02 |
| 1.9999E−01 | 1.2460E−01 | 1.90014E−01 | −9.07782E−02 |
| 2.0998E−01 | 1.2641E−01 | 2.00015E−01 | −9.26323E−02 |
| 2.1998E−01 | 1.2797E−01 | 2.10015E−01 | −9.43380E−02 |
| 2.2998E−01 | 1.2931E−01 | 2.20016E−01 | −9.59042E−02 |
| 2.3998E−01 | 1.3042E−01 | 2.30017E−01 | −9.73400E−02 |
| 2.4998E−01 | 1.3132E−01 | 2.40018E−01 | −9.86543E−02 |
| 2.5998E−01 | 1.3201E−01 | 2.50018E−01 | −9.98552E−02 |
| 2.6998E−01 | 1.3251E−01 | 2.60019E−01 | −1.00950E−01 |
| 2.7998E−01 | 1.3282E−01 | 2.70020E−01 | −1.01944E−01 |
| 2.8998E−01 | 1.3295E−01 | 2.80020E−01 | −1.02841E−01 |
| 2.9998E−01 | 1.3291E−01 | 2.90021E−01 | −1.03644E−01 |
| 3.0998E−01 | 1.3272E−01 | 3.00022E−01 | −1.04352E−01 |
| 3.1998E−01 | 1.3238E−01 | 3.10023E−01 | −1.04963E−01 |
| 3.2998E−01 | 1.3190E−01 | 3.20023E−01 | −1.05474E−01 |
| 3.3998E−01 | 1.3130E−01 | 3.30024E−01 | −1.05878E−01 |
| 3.4997E−01 | 1.3058E−01 | 3.40025E−01 | −1.06166E−01 |
| 3.5997E−01 | 1.2975E−01 | 3.50026E−01 | −1.06330E−01 |
| 3.6997E−01 | 1.2882E−01 | 3.60026E−01 | −1.06359E−01 |
| 3.7997E−01 | 1.2779E−01 | 3.70027E−01 | −1.06241E−01 |
| 3.8997E−01 | 1.2668E−01 | 3.80028E−01 | −1.05964E−01 |
| 3.9997E−01 | 1.2548E−01 | 3.90028E−01 | −1.05514E−01 |
| 4.0997E−01 | 1.2421E−01 | 4.00029E−01 | −1.04879E−01 |
| 4.1997E−01 | 1.2286E−01 | 4.10030E−01 | −1.04047E−01 |
| 4.2997E−01 | 1.2145E−01 | 4.20031E−01 | −1.03007E−01 |
| 4.3997E−01 | 1.1998E−01 | 4.30031E−01 | −1.01749E−01 |
| 4.4997E−01 | 1.1845E−01 | 4.40032E−01 | −1.00266E−01 |
| 4.5997E−01 | 1.1687E−01 | 4.50033E−01 | −9.85508E−02 |
| 4.6997E−01 | 1.1523E−01 | 4.60034E−01 | −9.66001E−02 |
| 4.7996E−01 | 1.1355E−01 | 4.70034E−01 | −9.44130E−02 |
| 4.8996E−01 | 1.1182E−01 | 4.80035E−01 | −9.19912E−02 |
| 4.9996E−01 | 1.1005E−01 | 4.90036E−01 | −8.93397E−02 |
| 5.0996E−01 | 1.0825E−01 | 5.00036E−01 | −8.64664E−02 |
| 5.1996E−01 | 1.0641E−01 | 5.10037E−01 | −8.33821E−02 |
| 5.2996E−01 | 1.0455E−01 | 5.20038E−01 | −8.01011E−02 |
| 5.3996E−01 | 1.0266E−01 | 5.30039E−01 | −7.66404E−02 |
| 5.4996E−01 | 1.0075E−01 | 5.40039E−01 | −7.30197E−02 |
| 5.5996E−01 | 9.8827E−02 | 5.50040E−01 | −6.92614E−02 |
| 5.6996E−01 | 9.6891E−02 | 5.60041E−01 | −6.53902E−02 |
| 5.7996E−01 | 9.4948E−02 | 5.70042E−01 | −6.14324E−02 |
| 5.8996E−01 | 9.3001E−02 | 5.80042E−01 | −5.74161E−02 |
| 5.9996E−01 | 9.1055E−02 | 5.90043E−01 | −5.33700E−02 |
| 6.0996E−01 | 8.9112E−02 | 6.00044E−01 | −4.93238E−02 |
| 6.1995E−01 | 8.7175E−02 | 6.10044E−01 | −4.53068E−02 |
| 6.2995E−01 | 8.5246E−02 | 6.20045E−01 | −4.13478E−02 |
| 6.3995E−01 | 8.3328E−02 | 6.30046E−01 | −3.74746E−02 |
| 6.4995E−01 | 8.1421E−02 | 6.40047E−01 | −3.37133E−02 |
| 6.5995E−01 | 7.9526E−02 | 6.50047E−01 | −3.00876E−02 |
| 6.6995E−01 | 7.7643E−02 | 6.60048E−01 | −2.66189E−02 |
| 6.7995E−01 | 7.5769E−02 | 6.70049E−01 | −2.33250E−02 |
| 6.8995E−01 | 7.3904E−02 | 6.80050E−01 | −2.02206E−02 |
| 6.9995E−01 | 7.2045E−02 | 6.90050E−01 | −1.73163E−02 |
| 7.0995E−01 | 7.0189E−02 | 7.00051E−01 | −1.46185E−02 |
| 7.1995E−01 | 6.8332E−02 | 7.10052E−01 | −1.21297E−02 |
| 7.2995E−01 | 6.6470E−02 | 7.20052E−01 | −9.84780E−03 |
| 7.3995E−01 | 6.4601E−02 | 7.30053E−01 | −7.76671E−03 |
| 7.4995E−01 | 6.2719E−02 | 7.40054E−01 | −5.87631E−03 |
| 7.5994E−01 | 6.0823E−02 | 7.50055E−01 | −4.16285E−03 |
| 7.6994E−01 | 5.8908E−02 | 7.60055E−01 | −2.60945E−03 |
| 7.7994E−01 | 5.6975E−02 | 7.70056E−01 | −1.19672E−03 |
| 7.8994E−01 | 5.5022E−02 | 7.80057E−01 | 9.64669E−05 |
| 7.9994E−01 | 5.3050E−02 | 7.90058E−01 | 1.29213E−03 |
| 8.0994E−01 | 5.1062E−02 | 8.00058E−01 | 2.41210E−03 |
| 8.1994E−01 | 4.9061E−02 | 8.10059E−01 | 3.47696E−03 |
| 8.2994E−01 | 4.7055E−02 | 8.20060E−01 | 4.50481E−03 |
| 8.3994E−01 | 4.5049E−02 | 8.30061E−01 | 5.50999E−03 |
| 8.4994E−01 | 4.3052E−02 | 8.40061E−01 | 6.50181E−03 |
| 8.5994E−01 | 4.1073E−02 | 8.50062E−01 | 7.48325E−03 |
| 8.6994E−01 | 3.9119E−02 | 8.60063E−01 | 8.44976E−03 |
| 8.7994E−01 | 3.7198E−02 | 8.70063E−01 | 9.38813E−03 |
| 8.8994E−01 | 3.5311E−02 | 8.80064E−01 | 1.02756E−02 |
| 8.9993E−01 | 3.3455E−02 | 8.90065E−01 | 1.10790E−02 |
| 9.0993E−01 | 3.1619E−02 | 9.00066E−01 | 1.17549E−02 |
| 9.1993E−01 | 2.9778E−02 | 9.10066E−01 | 1.22490E−02 |
| 9.2993E−01 | 2.7891E−02 | 9.20067E−01 | 1.24975E−02 |
| 9.3993E−01 | 2.5894E−02 | 9.30068E−01 | 1.24280E−02 |
| 9.4993E−01 | 2.3695E−02 | 9.40069E−01 | 1.19618E−02 |
| 9.5993E−01 | 2.1166E−02 | 9.50069E−01 | 1.10167E−02 |
| 9.6993E−01 | 1.8133E−02 | 9.60070E−01 | 9.51184E−03 |
| 9.7993E−01 | 1.4364E−02 | 9.70071E−01 | 7.37263E−03 |
| 9.8993E−01 | 9.5598E−03 | 9.80071E−01 | 4.53815E−03 |
| 9.9993E−01 | 3.3377E−03 | 9.90072E−01 | 9.69840E−04 |
| | | 1.00007E+00 | −3.33770E−03 |

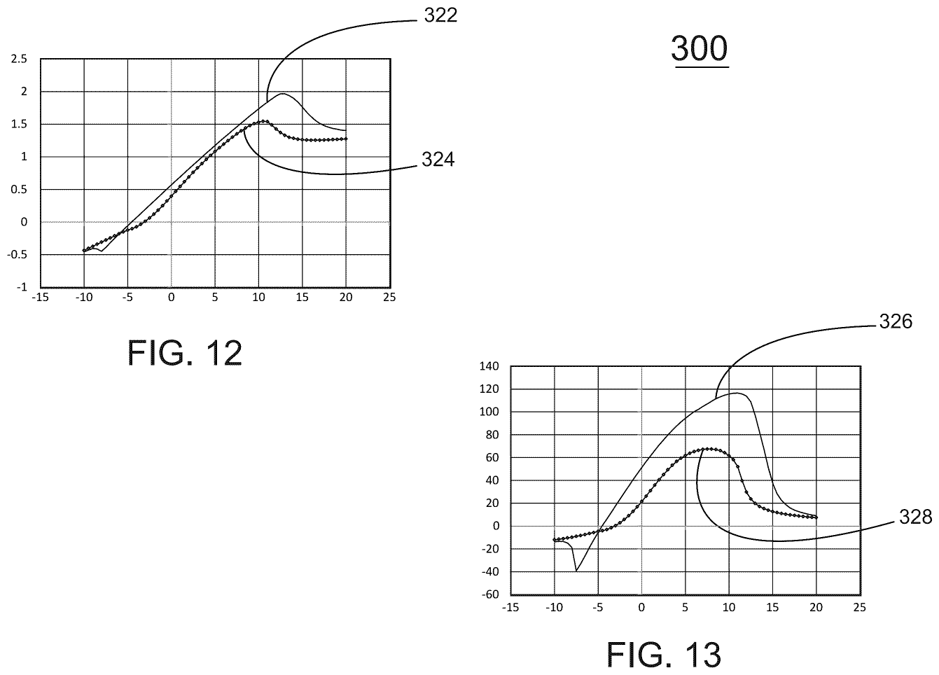

FIG. 12 depicts the performance of the airfoil 300 as a product of the coefficient of lift along the vertical axis and the angle of attack along the horizontal axis. Data points along curve 322 represent the performance of the airfoil 300 with a clean surface. Data points along the curve 324 represent the performance of the airfoil 300 with a rough surface as would occur when environmental debris collects on the surface of a rotor blade, resulting in higher turbulence. Given the higher maximum lift coefficient, the operating lift coefficient can be approximately 1.3 for both clean and rough surfaces.

FIG. 13 depicts the efficiency of the airfoil 300 as a product of the coefficient of lift over drag (L/D) along the vertical axis and the angle of attack (AoA) along the horizontal axis. Data points along curve 326 represent the efficiency of the airfoil 300 with a clean surface. Data points along curve 328 represent the efficiency of the airfoil 300 with a rough surface, as would occur when environmental debris collects on the surface of a rotor blade, resulting in higher turbulence. The maximum L/D over a clean surface can reach approximately 118, and approximately 68 over a rough surface.

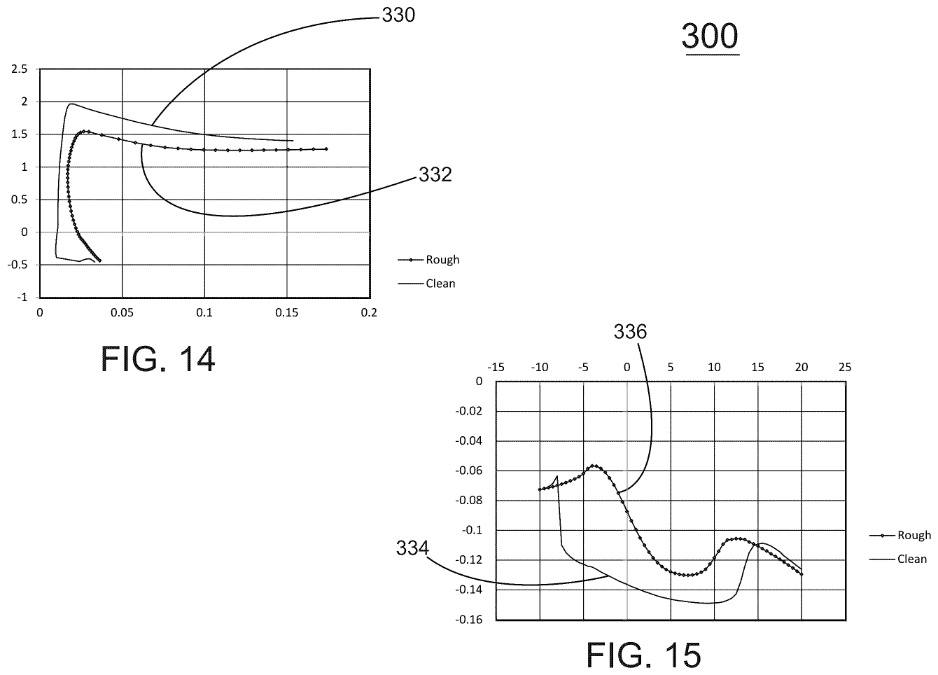

FIG. 14 depicts the performance of the airfoil 300 as a product of the lift coefficient (Cl) along the vertical axis and the drag coefficient (Cd) along the horizontal axis. Data points along curve 330 represent the performance of the airfoil 300 with a clean surface. Data points along the curve 332 represent the performance of the airfoil 300 with a rough surface, as would occur when environmental debris collects on the surface of a rotor blade, resulting in higher turbulence. The lift coefficient and drag coefficient of the airfoil described in FIG. 11 are contributing factors to the substantial insensitivity to surface texturing.

FIG. 15 depicts the performance of the airfoil 300 as a product of the pitch moment coefficient (Cm) along the vertical axis and the angle of attack (AoA) along the horizontal axis. Data points along curve 334 represent the performance of the airfoil 300 with a clean surface. Data points along the curve 336 represent the performance of the airfoil 300 with a rough surface as would occur when environmental debris collects on the surface of a rotor blade. This shows the pitching performance as a product of a relatively high absolute self-pitch moment coefficient.

1. An airfoil for a rotor blade comprising:
a lift surface extending from a leading edge to a trailing edge; and
a pressure surface extending from said leading edge to said trailing edge below said lift surface; and
a chord extending from said lift surface and said pressure surface at said leading edge to said lift surface and said pressure surface at said trailing edge; and
a thickness between said lift surface and said pressure surface that is between 17% and 19% of said chord; wherein
said airfoil provides a relatively high lift coefficient and a relatively high pitch-moment coefficient.

2. The airfoil for a rotor blade of claim 1 further comprising:
a substantially flat portion along said lift surface proximal to said trailing edge.

3. The airfoil for a rotor blade of claim 1 further comprising
a substantially flat portion along said pressure surface proximal to said leading edge.

4. The airfoil for a rotor blade of claim 1 wherein:
said lift surface resides above said chord.

5. The airfoil for a rotor blade of claim 1 further comprising:
said pressure surface resides substantially below said chord.

6. The airfoil for a rotor blade of claim 5 wherein:
a portion of said pressure surface, proximal to said trailing edge, resides above said chord and is between 19% and 35%.

7. The airfoil for a rotor blade of claim 5 wherein:
a portion of said pressure surface, proximal to said trailing edge, resides above said chord and is between 19% and 21%.

8. The airfoil for a rotor blade of claim 1 further comprising:
a pivot point proximal to said chord and proximal to said leading edge; and
a center of pressure proximal to said chord; wherein
an airfoil pitching moment is calculated about said pivot point; and
said center of pressure is a point in the airfoil cross-section where forces resulting from the pressure distribution yield no pitching moment.

9. The airfoil for a rotor blade of claim 8 wherein:
said pivot point resides approximately 25% of a distance between said leading edge and said trailing edge; and
said center of pressure resides approximately 33% of said distance between said leading edge and said trailing edge.

10. The airfoil for a rotor blade of claim 9 further comprising:
a relatively high camber downstream of said center of pressure, providing a relatively high lift-coefficient and a relatively high pitch-moment coefficient.

11. The airfoil of claim 1 wherein the specific geometric characteristics of the airfoil is given in the form of the following table of coordinates:

| Lift Surface 101P | | Pressure Surface 101P | |
|---|---|---|---|
| 0.0000E+00 | 0.0000E+00 | 0.0000E+00 | 0.0000E+00 |
| 1.0294E−04 | 1.9828E−03 | 2.2136E−05 | −9.4450E−04 |
| 3.3487E−04 | 3.5842E−03 | 1.7026E−04 | −2.6172E−03 |
| 6.9538E−04 | 5.1824E−03 | 4.4564E−04 | −4.2274E−03 |
| 1.1781E−03 | 6.7752E−03 | 8.4872E−04 | −5.8200E−03 |
| 1.7774E−03 | 8.3666E−03 | 1.3805E−03 | −7.3994E−03 |
| 2.4888E−03 | 9.9621E−03 | 2.0463E−03 | −8.9732E−03 |
| 3.3132E−03 | 1.1575E−02 | 2.8507E−03 | −1.0542E−02 |
| 4.2551E−03 | 1.3219E−02 | 3.7974E−03 | −1.2101E−02 |
| 5.3209E−03 | 1.4908E−02 | 4.8849E−03 | −1.3640E−02 |
| 7.8566E−03 | 1.8460E−02 | 7.4893E−03 | −1.6650E−02 |
| 1.0999E−02 | 2.2311E−02 | 1.0723E−02 | −1.9591E−02 |
| 1.4856E−02 | 2.6535E−02 | 1.4683E−02 | −2.2489E−02 |
| 2.0010E−02 | 3.1624E−02 | 1.9990E−02 | −2.5630E−02 |
| 3.0016E−02 | 4.0307E−02 | 2.9984E−02 | −3.0226E−02 |
| 4.0021E−02 | 4.7867E−02 | 3.9979E−02 | −3.3859E−02 |
| 5.0026E−02 | 5.4558E−02 | 4.9974E−02 | −3.6955E−02 |
| 6.0031E−02 | 6.0525E−02 | 5.9969E−02 | −3.9725E−02 |
| 7.0037E−02 | 6.5874E−02 | 6.9963E−02 | −4.2281E−02 |
| 8.0042E−02 | 7.0687E−02 | 7.9958E−02 | −4.4686E−02 |
| 9.0047E−02 | 7.5033E−02 | 8.9953E−02 | −4.6974E−02 |
| 1.0005E−01 | 7.8971E−02 | 9.9948E−02 | −4.9164E−02 |
| 1.1006E−01 | 8.2549E−02 | 1.0994E−01 | −5.1264E−02 |
| 1.2006E−01 | 8.5809E−02 | 1.1994E−01 | −5.3278E−02 |
| 1.3007E−01 | 8.8782E−02 | 1.2993E−01 | −5.5204E−02 |
| 1.4007E−01 | 9.1496E−02 | 1.3993E−01 | −5.7039E−02 |
| 1.5008E−01 | 9.3972E−02 | 1.4992E−01 | −5.8780E−02 |
| 1.6008E−01 | 9.6225E−02 | 1.5992E−01 | −6.0422E−02 |
| 1.7009E−01 | 9.8270E−02 | 1.6991E−01 | −6.1958E−02 |
| 1.8009E−01 | 1.0011E−01 | 1.7991E−01 | −6.3384E−02 |
| 1.9010E−01 | 1.0177E−01 | 1.8990E−01 | −6.4693E−02 |
| 2.0010E−01 | 1.0324E−01 | 1.9990E−01 | −6.5880E−02 |
| 2.1011E−01 | 1.0452E−01 | 2.0989E−01 | −6.6938E−02 |
| 2.2012E−01 | 1.0563E−01 | 2.1988E−01 | −6.7861E−02 |
| 2.3012E−01 | 1.0657E−01 | 2.2988E−01 | −6.8644E−02 |
| 2.4013E−01 | 1.0734E−01 | 2.3987E−01 | −6.9282E−02 |
| 2.5013E−01 | 1.0795E−01 | 2.4987E−01 | −6.9770E−02 |
| 2.6014E−01 | 1.0840E−01 | 2.5986E−01 | −7.0103E−02 |
| 2.7014E−01 | 1.0869E−01 | 2.6986E−01 | −7.0277E−02 |
| 2.8015E−01 | 1.0884E−01 | 2.7985E−01 | −7.0290E−02 |
| 2.9015E−01 | 1.0885E−01 | 2.8985E−01 | −7.0140E−02 |
| 3.0016E−01 | 1.0873E−01 | 2.9984E−01 | −6.9825E−02 |
| 3.1016E−01 | 1.0848E−01 | 3.0984E−01 | −6.9346E−02 |
| 3.2017E−01 | 1.0812E−01 | 3.1983E−01 | −6.8704E−02 |
| 3.3017E−01 | 1.0764E−01 | 3.2983E−01 | −6.7902E−02 |
| 3.4018E−01 | 1.0707E−01 | 3.3982E−01 | −6.6943E−02 |
| 3.5018E−01 | 1.0640E−01 | 3.4982E−01 | −6.5832E−02 |
| 3.6019E−01 | 1.0564E−01 | 3.5981E−01 | −6.4577E−02 |
| 3.7019E−01 | 1.0481E−01 | 3.6981E−01 | −6.3183E−02 |
| 3.8020E−01 | 1.0390E−01 | 3.7980E−01 | −6.1661E−02 |
| 3.9020E−01 | 1.0293E−01 | 3.8980E−01 | −6.0018E−02 |
| 4.0021E−01 | 1.0189E−01 | 3.9979E−01 | −5.8267E−02 |
| 4.1021E−01 | 1.0081E−01 | 4.0979E−01 | −5.6417E−02 |
| 4.2022E−01 | 9.9675E−02 | 4.1978E−01 | −5.4481E−02 |
| 4.3023E−01 | 9.8496E−02 | 4.2977E−01 | −5.2471E−02 |
| 4.4023E−01 | 9.7277E−02 | 4.3977E−01 | −5.0399E−02 |
| 4.5024E−01 | 9.6021E−02 | 4.4976E−01 | −4.8278E−02 |
| 4.6024E−01 | 9.4731E−02 | 4.5976E−01 | −4.6120E−02 |
| 4.7025E−01 | 9.3408E−02 | 4.6975E−01 | −4.3937E−02 |
| 4.8025E−01 | 9.2056E−02 | 4.7975E−01 | −4.1741E−02 |
| 4.9026E−01 | 9.0676E−02 | 4.8974E−01 | −3.9542E−02 |
| 5.0026E−01 | 8.9270E−02 | 4.9974E−01 | −3.7351E−02 |
| 5.1027E−01 | 8.7838E−02 | 5.0973E−01 | −3.5178E−02 |
| 5.2027E−01 | 8.6383E−02 | 5.1973E−01 | −3.3029E−02 |
| 5.3028E−01 | 8.4904E−02 | 5.2972E−01 | −3.0913E−02 |
| 5.4028E−01 | 8.3405E−02 | 5.3972E−01 | −2.8835E−02 |
| 5.5029E−01 | 8.1885E−02 | 5.4971E−01 | −2.6800E−02 |
| 5.6029E−01 | 8.0347E−02 | 5.5971E−01 | −2.4812E−02 |
| 5.7030E−01 | 7.8792E−02 | 5.6970E−01 | −2.2873E−02 |
| 5.8030E−01 | 7.7221E−02 | 5.7970E−01 | −2.0985E−02 |
| 5.9031E−01 | 7.5637E−02 | 5.8969E−01 | −1.9148E−02 |
| 6.0031E−01 | 7.4040E−02 | 5.9969E−01 | −1.7361E−02 |
| 6.1032E−01 | 7.2434E−02 | 6.0968E−01 | −1.5624E−02 |
| 6.2032E−01 | 7.0821E−02 | 6.1968E−01 | −1.3934E−02 |
| 6.3033E−01 | 6.9202E−02 | 6.2967E−01 | −1.2288E−02 |
| 6.4033E−01 | 6.7579E−02 | 6.3967E−01 | −1.0686E−02 |
| 6.5034E−01 | 6.5954E−02 | 6.4966E−01 | −9.1221E−03 |
| 6.6035E−01 | 6.4330E−02 | 6.5965E−01 | −7.5958E−03 |
| 6.7035E−01 | 6.2707E−02 | 6.6965E−01 | −6.1041E−03 |
| 6.8036E−01 | 6.1088E−02 | 6.7964E−01 | −4.6455E−03 |
| 6.9036E−01 | 5.9472E−02 | 6.8964E−01 | −3.2189E−03 |
| 7.0037E−01 | 5.7861E−02 | 6.9963E−01 | −1.8240E−03 |
| 7.1037E−01 | 5.6254E−02 | 7.0963E−01 | −4.6167E−04 |
| 7.2038E−01 | 5.4652E−02 | 7.1962E−01 | 8.6637E−04 |
| 7.3038E−01 | 5.3054E−02 | 7.2962E−01 | 2.1571E−03 |
| 7.4039E−01 | 5.1458E−02 | 7.3961E−01 | 3.4064E−03 |
| 7.5039E−01 | 4.9864E−02 | 7.4961E−01 | 4.6091E−03 |
| 7.6040E−01 | 4.8269E−02 | 7.5960E−01 | 5.7586E−03 |
| 7.7040E−01 | 4.6672E−02 | 7.6960E−01 | 6.8477E−03 |
| 7.8041E−01 | 4.5071E−02 | 7.7959E−01 | 7.8683E−03 |
| 7.9041E−01 | 4.3464E−02 | 7.8959E−01 | 8.8114E−03 |
| 8.0042E−01 | 4.1849E−02 | 7.9958E−01 | 9.6679E−03 |
| 8.1042E−01 | 4.0224E−02 | 8.0958E−01 | 1.0429E−02 |
| 8.2043E−01 | 3.8589E−02 | 8.1957E−01 | 1.1084E−02 |
| 8.3043E−01 | 3.6942E−02 | 8.2957E−01 | 1.1626E−02 |
| 8.4044E−01 | 3.5283E−02 | 8.3956E−01 | 1.2046E−02 |
| 8.5044E−01 | 3.3613E−02 | 8.4956E−01 | 1.2337E−02 |
| 8.6045E−01 | 3.1931E−02 | 8.5955E−01 | 1.2495E−02 |
| 8.7046E−01 | 3.0238E−02 | 8.6954E−01 | 1.2514E−02 |
| 8.8046E−01 | 2.8535E−02 | 8.7954E−01 | 1.2392E−02 |
| 8.9047E−01 | 2.6820E−02 | 8.8953E−01 | 1.2128E−02 |
| 9.0047E−01 | 2.5091E−02 | 8.9953E−01 | 1.1721E−02 |
| 9.1048E−01 | 2.3343E−02 | 9.0952E−01 | 1.1172E−02 |
| 9.2048E−01 | 2.1567E−02 | 9.1952E−01 | 1.0480E−02 |
| 9.3049E−01 | 1.9746E−02 | 9.2951E−01 | 9.6439E−03 |
| 9.4049E−01 | 1.7857E−02 | 9.3951E−01 | 8.6584E−03 |
| 9.5050E−01 | 1.5864E−02 | 9.4950E−01 | 7.5129E−03 |
| 9.6050E−01 | 1.3718E−02 | 9.5950E−01 | 6.1883E−03 |
| 9.7051E−01 | 1.1348E−02 | 9.6949E−01 | 4.6536E−03 |
| 9.8051E−01 | 8.6612E−03 | 9.7949E−01 | 2.8613E−03 |
| 9.9052E−01 | 5.5329E−03 | 9.8948E−01 | 7.4221E−04 |
| 1.0005E+00 | 1.8014E−03 | 9.9948E−01 | −1.8014E−03 |

12. The airfoil of claim 1 wherein the specific geometric characteristics of the airfoil is given in the form of the following table of coordinates:

| Lift Surface 101P | | Pressure Surface 101P | |
|---|---|---|---|
| 0.0000E+00 | 0.0000E+00 | 0.0000E+00 | 0.0000E+00 |
| 1.7414E−04 | 3.6975E−03 | 7.7634E−05 | −2.4515E−03 |
| 5.8132E−04 | 6.7602E−03 | 3.4299E−04 | −5.1414E−03 |
| 1.1445E−03 | 9.4941E−03 | 8.3229E−04 | −7.9764E−03 |
| 1.8448E−03 | 1.2067E−02 | 1.5465E−03 | −1.0809E−02 |
| 2.7117E−03 | 1.4649E−02 | 2.4363E−03 | −1.3469E−02 |
| 3.7658E−03 | 1.7290E−02 | 3.4819E−03 | −1.5968E−02 |
| 5.0043E−03 | 1.9966E−02 | 4.6744E−03 | −1.8330E−02 |
| 6.4334E−03 | 2.2681E−02 | 5.9971E−03 | −2.0556E−02 |
| 1.0020E−02 | 2.8428E−02 | 7.4410E−03 | −2.2655E−02 |
| 1.4279E−02 | 3.4084E−02 | 1.0755E−02 | −2.6616E−02 |
| 2.0000E−02 | 4.0527E−02 | 1.4812E−02 | −3.0439E−02 |
| 3.0000E−02 | 4.9906E−02 | 2.0000E−02 | −3.4342E−02 |
| 4.0000E−02 | 5.7779E−02 | 3.0000E−02 | −4.0138E−02 |
| 5.0000E−02 | 6.4627E−02 | 4.0000E−02 | −4.4726E−02 |
| 6.0000E−02 | 7.0703E−02 | 5.0000E−02 | −4.8675E−02 |
| 7.0000E−02 | 7.6161E−02 | 6.0000E−02 | −5.2239E−02 |
| 8.0000E−02 | 8.1107E−02 | 7.0000E−02 | −5.5530E−02 |
| 9.0000E−02 | 8.5616E−02 | 8.0000E−02 | −5.8599E−02 |
| 1.0000E−01 | 8.9744E−02 | 9.0000E−02 | −6.1466E−02 |
| 1.1000E−01 | 9.3534E−02 | 1.0000E−01 | −6.4136E−02 |
| 1.2000E−01 | 9.7018E−02 | 1.1000E−01 | −6.6613E−02 |
| 1.3000E−01 | 1.0022E−01 | 1.2000E−01 | −6.8899E−02 |
| 1.4000E−01 | 1.0316E−01 | 1.3000E−01 | −7.1001E−02 |
| 1.5000E−01 | 1.0585E−01 | 1.4000E−01 | −7.2925E−02 |
| 1.6000E−01 | 1.0831E−01 | 1.5000E−01 | −7.4683E−02 |
| 1.7000E−01 | 1.1054E−01 | 1.6000E−01 | −7.6285E−02 |
| 1.8000E−01 | 1.1255E−01 | 1.7000E−01 | −7.7745E−02 |
| 1.9000E−01 | 1.1435E−01 | 1.8000E−01 | −7.9072E−02 |
| 2.0000E−01 | 1.1594E−01 | 1.9000E−01 | −8.0277E−02 |
| 2.1000E−01 | 1.1732E−01 | 2.0000E−01 | −8.1367E−02 |
| 2.2000E−01 | 1.1851E−01 | 2.1000E−01 | −8.2348E−02 |
| 2.3000E−01 | 1.1950E−01 | 2.2000E−01 | −8.3222E−02 |
| 2.4000E−01 | 1.2030E−01 | 2.3000E−01 | −8.3987E−02 |
| 2.5000E−01 | 1.2093E−01 | 2.4000E−01 | −8.4640E−02 |
| 2.6000E−01 | 1.2137E−01 | 2.5000E−01 | −8.5173E−02 |
| 2.7000E−01 | 1.2165E−01 | 2.6000E−01 | −8.5577E−02 |
| 2.8000E−01 | 1.2176E−01 | 2.7000E−01 | −8.5840E−02 |
| 2.9000E−01 | 1.2172E−01 | 2.8000E−01 | −8.5949E−02 |
| 3.0000E−01 | 1.2153E−01 | 2.9000E−01 | −8.5891E−02 |
| 3.1000E−01 | 1.2120E−01 | 3.0000E−01 | −8.5650E−02 |
| 3.2000E−01 | 1.2074E−01 | 3.1000E−01 | −8.5214E−02 |
| 3.3000E−01 | 1.2016E−01 | 3.2000E−01 | −8.4568E−02 |
| 3.4000E−01 | 1.1947E−01 | 3.3000E−01 | −8.3703E−02 |
| 3.5000E−01 | 1.1868E−01 | 3.4000E−01 | −8.2608E−02 |
| 3.6000E−01 | 1.1779E−01 | 3.5000E−01 | −8.1277E−02 |
| 3.7000E−01 | 1.1681E−01 | 3.6000E−01 | −7.9706E−02 |
| 3.8000E−01 | 1.1576E−01 | 3.7000E−01 | −7.7894E−02 |
| 3.9000E−01 | 1.1463E−01 | 3.8000E−01 | −7.5844E−02 |
| 4.0000E−01 | 1.1344E−01 | 3.9000E−01 | −7.3562E−02 |
| 4.1000E−01 | 1.1219E−01 | 4.0000E−01 | −7.1056E−02 |
| 4.2000E−01 | 1.1088E−01 | 4.1000E−01 | −6.8342E−02 |
| 4.3000E−01 | 1.0953E−01 | 4.2000E−01 | −6.5433E−02 |
| 4.4000E−01 | 1.0814E−01 | 4.3000E−01 | −6.2350E−02 |
| 4.5000E−01 | 1.0671E−01 | 4.4000E−01 | −5.9115E−02 |
| 4.6000E−01 | 1.0525E−01 | 4.5000E−01 | −5.5750E−02 |
| 4.7000E−01 | 1.0375E−01 | 4.6000E−01 | −5.2283E−02 |
| 4.8000E−01 | 1.0223E−01 | 4.7000E−01 | −4.8739E−02 |
| 4.9000E−01 | 1.0068E−01 | 4.8000E−01 | −4.5148E−02 |
| 5.0000E−01 | 9.9104E−02 | 4.9000E−01 | −4.1537E−02 |
| 5.1000E−01 | 9.7507E−02 | 5.0000E−01 | −3.7934E−02 |
| 5.2000E−01 | 9.5889E−02 | 5.1000E−01 | −3.4367E−02 |
| 5.3000E−01 | 9.4250E−02 | 5.2000E−01 | −3.0861E−02 |
| 5.4000E−01 | 9.2592E−02 | 5.3000E−01 | −2.7441E−02 |
| 5.5000E−01 | 9.0915E−02 | 5.4000E−01 | −2.4129E−02 |
| 5.6000E−01 | 8.9219E−02 | 5.5000E−01 | −2.0945E−02 |
| 5.7000E−01 | 8.7507E−02 | 5.6000E−01 | −1.7906E−02 |
| 5.8000E−01 | 8.5778E−02 | 5.7000E−01 | −1.5025E−02 |
| 5.9000E−01 | 8.4033E−02 | 5.8000E−01 | −1.2313E−02 |
| 6.0000E−01 | 8.2274E−02 | 5.9000E−01 | −9.7786E−03 |
| 6.1000E−01 | 8.0502E−02 | 6.0000E−01 | −7.4244E−03 |
| 6.2000E−01 | 7.8718E−02 | 6.1000E−01 | −5.2517E−03 |
| 6.3000E−01 | 7.6925E−02 | 6.2000E−01 | −3.2585E−03 |
| 6.4000E−01 | 7.5125E−02 | 6.3000E−01 | −1.4394E−03 |
| 6.5000E−01 | 7.3319E−02 | 6.4000E−01 | 2.1306E−04 |
| 6.6000E−01 | 7.1510E−02 | 6.5000E−01 | 1.7089E−03 |
| 6.7000E−01 | 6.9701E−02 | 6.6000E−01 | 3.0599E−03 |
| 6.8000E−01 | 6.7895E−02 | 6.7000E−01 | 4.2793E−03 |
| 6.9000E−01 | 6.6094E−02 | 6.8000E−01 | 5.3810E−03 |
| 7.0000E−01 | 6.4301E−02 | 6.9000E−01 | 6.3797E−03 |
| 7.1000E−01 | 6.2519E−02 | 7.0000E−01 | 7.2897E−03 |
| 7.2000E−01 | 6.0751E−02 | 7.1000E−01 | 8.1251E−03 |
| 7.3000E−01 | 5.9000E−02 | 7.2000E−01 | 8.8988E−03 |
| 7.4000E−01 | 5.7267E−02 | 7.3000E−01 | 9.6223E−03 |
| 7.5000E−01 | 5.5555E−02 | 7.4000E−01 | 1.0305E−02 |
| 7.6000E−01 | 5.3865E−02 | 7.5000E−01 | 1.0955E−02 |
| 7.7000E−01 | 5.2199E−02 | 7.6000E−01 | 1.1578E−02 |
| 7.8000E−01 | 5.0555E−02 | 7.7000E−01 | 1.2176E−02 |
| 7.9000E−01 | 4.8935E−02 | 7.8000E−01 | 1.2750E−02 |
| 8.0000E−01 | 4.7336E−02 | 7.9000E−01 | 1.3298E−02 |
| 8.1000E−01 | 4.5756E−02 | 8.0000E−01 | 1.3815E−02 |
| 8.2000E−01 | 4.4191E−02 | 8.1000E−01 | 1.4295E−02 |
| 8.3000E−01 | 4.2636E−02 | 8.2000E−01 | 1.4730E−02 |
| 8.4000E−01 | 4.1084E−02 | 8.3000E−01 | 1.5111E−02 |
| 8.5000E−01 | 3.9528E−02 | 8.4000E−01 | 1.5426E−02 |
| 8.6000E−01 | 3.7957E−02 | 8.5000E−01 | 1.5667E−02 |
| 8.7000E−01 | 3.6359E−02 | 8.6000E−01 | 1.5820E−02 |
| 8.8000E−01 | 3.4717E−02 | 8.7000E−01 | 1.5877E−02 |
| 8.9000E−01 | 3.3016E−02 | 8.8000E−01 | 1.5826E−02 |
| 9.0000E−01 | 3.1233E−02 | 8.9000E−01 | 1.5657E−02 |
| 9.1000E−01 | 2.9343E−02 | 9.0000E−01 | 1.5362E−02 |
| 9.2000E−01 | 2.7317E−02 | 9.1000E−01 | 1.4928E−02 |
| 9.3000E−01 | 2.5121E−02 | 9.2000E−01 | 1.4344E−02 |
| 9.4000E−01 | 2.2714E−02 | 9.3000E−01 | 1.3592E−02 |
| 9.5000E−01 | 2.0049E−02 | 9.4000E−01 | 1.2647E−02 |
| 9.6000E−01 | 1.7071E−02 | 9.5000E−01 | 1.1475E−02 |
| 9.7000E−01 | 1.3715E−02 | 9.6000E−01 | 1.0025E−02 |
| 9.8000E−01 | 9.9061E−03 | 9.7000E−01 | 8.2225E−03 |
| 9.9000E−01 | 5.5555E−03 | 9.8000E−01 | 5.9637E−03 |
| 1.0000E+00 | 5.6022E−04 | 9.9000E−01 | 3.1025E−03 |
| | | 1.0000E+00 | −5.6022E−04 |

13. The airfoil of claim 1 wherein the specific geometric characteristics of the airfoil is given in the form of the following table of coordinates:

| Lift Surface 101P | | Pressure Surface 101P | |
|---|---|---|---|
| 0.0000E+00 | 0.0000E+00 | 0.00000E+00 | 0.00000E+00 |
| 1.7114E−04 | 3.8069E−03 | 7.79584E−05 | −2.06736E−03 |
| 6.2150E−04 | 7.2573E−03 | 3.94491E−04 | −4.64553E−03 |
| 1.3842E−03 | 1.0836E−02 | 1.10821E−03 | −7.76639E−03 |
| 2.4289E−03 | 1.4363E−02 | 2.32409E−03 | −1.11980E−02 |
| 3.8483E−03 | 1.8093E−02 | 4.13169E−03 | −1.48365E−02 |
| 5.6101E−03 | 2.1864E−02 | 6.38815E−03 | −1.83093E−02 |
| 7.7721E−03 | 2.5759E−02 | 8.73237E−03 | −2.12481E−02 |
| 1.3256E−02 | 3.3709E−02 | 1.36266E−02 | −2.61700E−02 |
| 1.9972E−02 | 4.1455E−02 | 1.97003E−02 | −3.09958E−02 |
| 2.9998E−02 | 5.0903E−02 | 2.00015E−02 | −3.12107E−02 |
| 3.9997E−02 | 5.8847E−02 | 3.00022E−02 | −3.75008E−02 |
| 4.9996E−02 | 6.5834E−02 | 4.00029E−02 | −4.27306E−02 |
| 5.9996E−02 | 7.2133E−02 | 5.00036E−02 | −4.73674E−02 |
| 6.9995E−02 | 7.7901E−02 | 6.00044E−02 | −5.16352E−02 |
| 7.9994E−02 | 8.3237E−02 | 7.00051E−02 | −5.56500E−02 |
| 8.9993E−02 | 8.8206E−02 | 8.00058E−02 | −5.94710E−02 |
| 9.9993E−02 | 9.2850E−02 | 9.00066E−02 | −6.31267E−02 |
| 1.0999E−01 | 9.7198E−02 | 1.00007E−01 | −6.66275E−02 |
| 1.1999E−01 | 1.0127E−01 | 1.10008E−01 | −6.99745E−02 |
| 1.2999E−01 | 1.0507E−01 | 1.20009E−01 | −7.31639E−02 |
| 1.3999E−01 | 1.0862E−01 | 1.30009E−01 | −7.61905E−02 |
| 1.4999E−01 | 1.1191E−01 | 1.40010E−01 | −7.90491E−02 |
| 1.5999E−01 | 1.1495E−01 | 1.50011E−01 | −8.17364E−02 |
| 1.6999E−01 | 1.1773E−01 | 1.60012E−01 | −8.42509E−02 |
| 1.7999E−01 | 1.2027E−01 | 1.70012E−01 | −8.65936E−02 |
| 1.8999E−01 | 1.2256E−01 | 1.80013E−01 | −8.87676E−02 |
| 1.9999E−01 | 1.2460E−01 | 1.90014E−01 | −9.07782E−02 |
| 2.0998E−01 | 1.2641E−01 | 2.00015E−01 | −9.26323E−02 |
| 2.1998E−01 | 1.2797E−01 | 2.10015E−01 | −9.43380E−02 |
| 2.2998E−01 | 1.2931E−01 | 2.20016E−01 | −9.59042E−02 |
| 2.3998E−01 | 1.3042E−01 | 2.30017E−01 | −9.73400E−02 |
| 2.4998E−01 | 1.3132E−01 | 2.40018E−01 | −9.86543E−02 |
| 2.5998E−01 | 1.3201E−01 | 2.50018E−01 | −9.98552E−02 |
| 2.6998E−01 | 1.3251E−01 | 2.60019E−01 | −1.00950E−01 |
| 2.7998E−01 | 1.3282E−01 | 2.70020E−01 | −1.01944E−01 |
| 2.8998E−01 | 1.3295E−01 | 2.80020E−01 | −1.02841E−01 |
| 2.9998E−01 | 1.3291E−01 | 2.90021E−01 | −1.03644E−01 |
| 3.0998E−01 | 1.3272E−01 | 3.00022E−01 | −1.04352E−01 |
| 3.1998E−01 | 1.3238E−01 | 3.10023E−01 | −1.04963E−01 |
| 3.2998E−01 | 1.3190E−01 | 3.20023E−01 | −1.05474E−01 |
| 3.3998E−01 | 1.3130E−01 | 3.30024E−01 | −1.05878E−01 |
| 3.4997E−01 | 1.3058E−01 | 3.40025E−01 | −1.06166E−01 |
| 3.5997E−01 | 1.2975E−01 | 3.50026E−01 | −1.06330E−01 |
| 3.6997E−01 | 1.2882E−01 | 3.60026E−01 | −1.06359E−01 |
| 3.7997E−01 | 1.2779E−01 | 3.70027E−01 | −1.06241E−01 |
| 3.8997E−01 | 1.2668E−01 | 3.80028E−01 | −1.05964E−01 |
| 3.9997E−01 | 1.2548E−01 | 3.90028E−01 | −1.05514E−01 |
| 4.0997E−01 | 1.2421E−01 | 4.00029E−01 | −1.04879E−01 |
| 4.1997E−01 | 1.2286E−01 | 4.10030E−01 | −1.04047E−01 |
| 4.2997E−01 | 1.2145E−01 | 4.20031E−01 | −1.03007E−01 |
| 4.3997E−01 | 1.1998E−01 | 4.30031E−01 | −1.01749E−01 |
| 4.4997E−01 | 1.1845E−01 | 4.40032E−01 | −1.00266E−01 |
| 4.5997E−01 | 1.1687E−01 | 4.50033E−01 | −9.85508E−02 |
| 4.6997E−01 | 1.1523E−01 | 4.60034E−01 | −9.66001E−02 |
| 4.7996E−01 | 1.1355E−01 | 4.70034E−01 | −9.44130E−02 |
| 4.8996E−01 | 1.1182E−01 | 4.80035E−01 | −9.19912E−02 |
| 4.9996E−01 | 1.1005E−01 | 4.90036E−01 | −8.93397E−02 |
| 5.0996E−01 | 1.0825E−01 | 5.00036E−01 | −8.64664E−02 |
| 5.1996E−01 | 1.0641E−01 | 5.10037E−01 | −8.33821E−02 |
| 5.2996E−01 | 1.0455E−01 | 5.20038E−01 | −8.01011E−02 |
| 5.3996E−01 | 1.0266E−01 | 5.30039E−01 | −7.66404E−02 |
| 5.4996E−01 | 1.0075E−01 | 5.40039E−01 | −7.30197E−02 |
| 5.5996E−01 | 9.8827E−02 | 5.50040E−01 | −6.92614E−02 |
| 5.6996E−01 | 9.6891E−02 | 5.60041E−01 | −6.53902E−02 |
| 5.7996E−01 | 9.4948E−02 | 5.70042E−01 | −6.14324E−02 |
| 5.8996E−01 | 9.3001E−02 | 5.80042E−01 | −5.74161E−02 |
| 5.9996E−01 | 9.1055E−02 | 5.90043E−01 | −5.33700E−02 |
| 6.0996E−01 | 8.9112E−02 | 6.00044E−01 | −4.93238E−02 |
| 6.1995E−01 | 8.7175E−02 | 6.10044E−01 | −4.53068E−02 |
| 6.2995E−01 | 8.5246E−02 | 6.20045E−01 | −4.13478E−02 |
| 6.3995E−01 | 8.3328E−02 | 6.30046E−01 | −3.74746E−02 |
| 6.4995E−01 | 8.1421E−02 | 6.40047E−01 | −3.37133E−02 |
| 6.5995E−01 | 7.9526E−02 | 6.50047E−01 | −3.00876E−02 |
| 6.6995E−01 | 7.7643E−02 | 6.60048E−01 | −2.66189E−02 |
| 6.7995E−01 | 7.5769E−02 | 6.70049E−01 | −2.33250E−02 |
| 6.8995E−01 | 7.3904E−02 | 6.80050E−01 | −2.02206E−02 |
| 6.9995E−01 | 7.2045E−02 | 6.90050E−01 | −1.73163E−02 |
| 7.0995E−01 | 7.0189E−02 | 7.00051E−01 | −1.46185E−02 |
| 7.1995E−01 | 6.8332E−02 | 7.10052E−01 | −1.21297E−02 |
| 7.2995E−01 | 6.6470E−02 | 7.20052E−01 | −9.84780E−03 |
| 7.3995E−01 | 6.4601E−02 | 7.30053E−01 | −7.76671E−03 |
| 7.4995E−01 | 6.2719E−02 | 7.40054E−01 | −5.87631E−03 |
| 7.5994E−01 | 6.0823E−02 | 7.50055E−01 | −4.16285E−03 |
| 7.6994E−01 | 5.8908E−02 | 7.60055E−01 | −2.60945E−03 |
| 7.7994E−01 | 5.6975E−02 | 7.70056E−01 | −1.19672E−03 |
| 7.8994E−01 | 5.5022E−02 | 7.80057E−01 | 9.64669E−05 |
| 7.9994E−01 | 5.3050E−02 | 7.90058E−01 | 1.29213E−03 |
| 8.0994E−01 | 5.1062E−02 | 8.00058E−01 | 2.41210E−03 |
| 8.1994E−01 | 4.9061E−02 | 8.10059E−01 | 3.47696E−03 |
| 8.2994E−01 | 4.7055E−02 | 8.20060E−01 | 4.50481E−03 |
| 8.3994E−01 | 4.5049E−02 | 8.30061E−01 | 5.50999E−03 |
| 8.4994E−01 | 4.3052E−02 | 8.40061E−01 | 6.50181E−03 |
| 8.5994E−01 | 4.1073E−02 | 8.50062E−01 | 7.48325E−03 |
| 8.6994E−01 | 3.9119E−02 | 8.60063E−01 | 8.44976E−03 |
| 8.7994E−01 | 3.7198E−02 | 8.70063E−01 | 9.38813E−03 |
| 8.8994E−01 | 3.5311E−02 | 8.80064E−01 | 1.02756E−02 |
| 8.9993E−01 | 3.3455E−02 | 8.90065E−01 | 1.10790E−02 |
| 9.0993E−01 | 3.1619E−02 | 9.00066E−01 | 1.17549E−02 |
| 9.1993E−01 | 2.9778E−02 | 9.10066E−01 | 1.22490E−02 |
| 9.2993E−01 | 2.7891E−02 | 9.20067E−01 | 1.24975E−02 |
| 9.3993E−01 | 2.5894E−02 | 9.30068E−01 | 1.24280E−02 |
| 9.4993E−01 | 2.3695E−02 | 9.40069E−01 | 1.19618E−02 |
| 9.5993E−01 | 2.1166E−02 | 9.50069E−01 | 1.10167E−02 |
| 9.6993E−01 | 1.8133E−02 | 9.60070E−01 | 9.51184E−03 |
| 9.7993E−01 | 1.4364E−02 | 9.70071E−01 | 7.37263E−03 |
| 9.8993E−01 | 9.5598E−03 | 9.80071E−01 | 4.53815E−03 |
| 9.9993E−01 | 3.3377E−03 | 9.90072E−01 | 9.69840E−04 |
| | | 1.00007E+00 | −3.33770E−03 |
